(19) United States
(12) Patent Application Publication
(10) Pub. No.: US 2022/0344981 A1
(43) Pub. Date: Oct. 27, 2022

(54) LAMINATED CORE OF ELECTRIC MACHINE, ELECTRIC MACHINE, METHOD FOR MANUFACTURING LAMINATED CORE OF ELECTRIC MACHINE, AND METHOD FOR MANUFACTURING ELECTRIC MACHINE

(71) Applicant: Mitsubishi Electric Corporation, Chiyoda-ku, Tokyo (JP)

(72) Inventors: Takayuki ONIHASHI, Tokyo (JP); Koki NAKA, Tokyo (JP); Hiroki DAITO, Tokyo (JP); Kenji FUKUI, Tokyo (JP); Akira WATARAI, Tokyo (JP); Masaya INOUE, Tokyo (JP)

(73) Assignee: Mitsubishi Electric Corporation, Chiyoda-ku, Tokyo (JP)

(21) Appl. No.: 17/763,680

(22) PCT Filed: Jan. 21, 2020
(86) PCT No.: PCT/JP2020/001888

§ 371 Date: Mar. 25, 2022

(30) Foreign Application Priority Data
Dec. 2, 2019 (JP) 2019-217671

(51) Int. Cl. H02K 1/12; H02K 15/02

(52) U.S. Cl. CPC H02K 1/12; H02K 15/02

(57) ABSTRACT

A laminated core for an electric machine includes a plurality of laminated core pieces. Each of the plurality of core pieces includes a first portion and a second portion having a plate thickness smaller than a plate thickness of the first portion.

### TECHNICAL FIELD

The present invention relates to a laminated core for an electric machine, an electric machine, a manufacturing method for a laminated core for an electric machine, and a manufacturing method for an electric machine.

### BACKGROUND ART

In Patent Literature 1, a rotating electric machine including a stator core is described. The stator core includes a plurality of divided laminated cores arranged in an annular shape in a circumferential direction. Each of the divided laminated cores includes a back yoke portion, and a tooth portion protruding from the back yoke portion to a radially inner side. Each of the divided laminated cores has a configuration in which core pieces are laminated in an axial direction.

### CITATION LIST

### Patent Literature

[PTL 1] JP 2017-163675 A

### SUMMARY OF INVENTION

### Technical Problem

When a rotation speed is increased in the rotating electric machine as described above, the rotating electric machine can be increased in output and reduced in size. However, when the rotation speed of the rotating electric machine is increased, there is a problem in that an iron loss, in particular, an eddy current loss in the stator core is increased.

The present invention has been made in order to solve the problem as described above, and has an object to provide a laminated core for an electric machine, an electric machine, a manufacturing method for a laminated core for an electric machine, and a manufacturing method for an electric machine, which are capable of reducing an eddy current loss.

### Solution to Problem

A laminated core for an electric machine according to the present invention includes a plurality of laminated core pieces, wherein each of the plurality of core pieces includes: a first portion; and a second portion having a plate thickness smaller than a plate thickness of the first portion.

A laminated core for an electric machine according to the present invention includes a plurality of laminated core pieces, wherein the plurality of core pieces include: a third core piece; and a fourth core piece having a plate thickness smaller than a plate thickness of the third core piece, and wherein a first core piece group including one or more third core pieces and a second core piece group including one or more fourth core pieces are alternately arranged in a laminating direction of the plurality of core pieces.

An electric machine according to the present invention includes: an armature including the laminated core for an electric machine according to the present invention; and a field system arranged so as to be opposed to the armature via an air gap.

A manufacturing method for a laminated core for an electric machine according to the present invention is a method of manufacturing the laminated core for an electric machine according to the present invention. The manufacturing method includes: a crushing step of crushing at least a part of a steel sheet to form a thin portion that serves as the second portion; and a punching step of punching out each of the plurality of core pieces from the steel sheet after the crushing step.

A manufacturing method for an electric machine according to the present invention includes the manufacturing method for a laminated core for an electric machine according to the present invention.

### Advantageous Effects of Invention

According to the present invention, the eddy current loss in the laminated core for an electric machine can be reduced.

### BRIEF DESCRIPTION OF DRAWINGS

FIG. 1 is a sectional view for illustrating a schematic configuration of a rotating electric machine according to a first embodiment.

FIG. 2 is a perspective view for illustrating a configuration of a stator core according to the first embodiment.

FIG. 3 is a perspective view for illustrating a configuration of one core piece in a comparative example of the first embodiment.

FIG. 4 is a sectional view for illustrating a configuration in which two core pieces are laminated in the comparative example of the first embodiment.

FIG. 5 is a perspective view for illustrating a configuration of a core piece of a divided laminated core according to the first embodiment.

FIG. 6 is a perspective view for illustrating a configuration of another core piece of the divided laminated core according to the first embodiment.

FIG. 7 is a sectional view for illustrating a configuration in which two core pieces according to the first embodiment are laminated.

FIG. 8 is a perspective view for illustrating a configuration of the divided laminated core according to the first embodiment.

FIG. 9 is a view for illustrating a configuration in which a distal end portion of a tooth-portion laminate of the divided laminated core according to the first embodiment is viewed along a radial direction.

FIG. 10 is a sectional view for illustrating a configuration in which a part of the divided laminated core according to the first embodiment is taken along a plane perpendicular to an extending direction of a first portion and a second portion.

FIG. 11 is a flowchart for illustrating a flow of a manufacturing process of the divided laminated core according to the first embodiment.

FIG. 12 is a conceptual diagram for illustrating the flow of the manufacturing process of the divided laminated core according to the first embodiment.

FIG. 13 is a sectional view for illustrating a configuration of a steel sheet after a crushing step in the manufacturing process of the divided laminated core according to the first embodiment.

FIG. 14 is a perspective view for illustrating a configuration of a divided laminated core according to a second embodiment.

FIG. 15 is a view for illustrating the XV portion of FIG. 14 in an enlarged manner.

FIG. 16 is a perspective view for illustrating a configuration of a divided laminated core according to a comparative example of the second embodiment.

FIG. 17 is a view for illustrating the XVII portion of FIG. 16 in an enlarged manner.

FIG. 18 is a perspective view for illustrating a first modification example of the configuration of the divided laminated core according to the second embodiment.

FIG. 19 is a view for illustrating the XIX portion of FIG. 18 in an enlarged manner.

FIG. 20 is a view for illustrating a second modification example of the configuration of the divided laminated core according to the second embodiment.

FIG. 21 is a partial sectional view for illustrating a third modification example of the configuration of the divided laminated core according to the second embodiment.

FIG. 22 is a perspective view for illustrating a configuration of a core piece of a divided laminated core according to a third embodiment.

FIG. 23 is a perspective view for illustrating a configuration of a core piece of a divided laminated core according to a fourth embodiment.

FIG. 24 is a perspective view for illustrating a configuration of a core piece of a divided laminated core according to a fifth embodiment.

FIG. 25 is a perspective view for illustrating a configuration of a core piece of a stator core according to a sixth embodiment.

FIG. 26 is a plan view for illustrating a configuration of a core piece of a stator core according to a seventh embodiment.

FIG. 27 is a sectional view for illustrating a schematic configuration of a rotating electric machine according to an eighth embodiment.

### DESCRIPTION OF EMBODIMENTS

### First Embodiment

A laminated core for an electric machine, an electric machine, a manufacturing method for a laminated core for an electric machine, and a manufacturing method for an electric machine according to a first embodiment are described. First, configurations of the laminated core for an electric machine and the electric machine according to this embodiment are described. In this embodiment, as the electric machine, a rotating electric machine including a stator and a rotator is described as an example. Examples of the rotating electric machine include an electric motor and a power generator. Herein, an axial direction of a stator core, a radial direction of the stator core, and a circumferential direction of the stator core may simply be referred to as “axial direction”, “radial direction”, and “circumferential direction”, respectively. Further, an inner peripheral side of the stator core, an outer peripheral side of the stator core, an inner side of the stator core, and an outer side of the stator core may simply be referred to as “inner peripheral side”, “outer peripheral side”, “inner side”, and “outer side”, respectively.

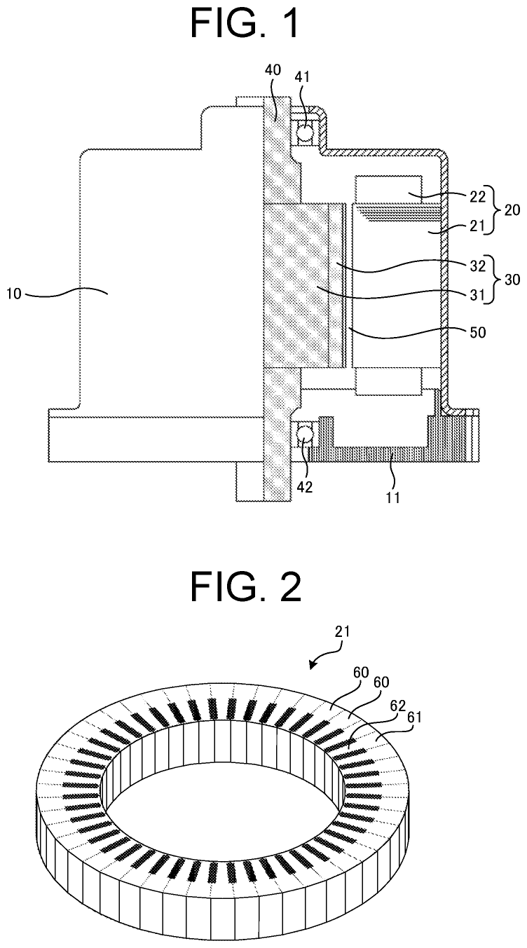

FIG. 1 is a sectional view for illustrating a schematic configuration of the rotating electric machine according to this embodiment. As illustrated in FIG. 1, the rotating electric machine includes a housing 10, a stator 20, a rotator 30, and a shaft 40. The housing 10, the stator 20, the rotator 30, and the shaft 40 are arranged in the stated order from an outer peripheral side to an inner peripheral side. An air gap 50 is defined between an inner peripheral surface of the stator 20 and an outer peripheral surface of the rotator 30.

The stator 20 is an armature of the rotating electric machine which is configured to generate a rotating magnetic field. The rotator 30 is a field system of the rotating electric machine. The rotator 30 is rotatably provided on an inner peripheral side of the stator 20. The rotator 30 is opposed to the stator 20 via the air gap 50. The stator 20 and the rotator 30 are held by the housing 10.

The stator 20 includes a stator core 21 and a stator winding 22. The stator core 21 allows a magnetic flux to flow therethrough. The stator winding 22 is formed by winding a conductor and is configured to generate a magnetic field by energization. The stator core 21 is an armature core of the rotating electric machine. The stator core 21 and the stator winding 22 are insulated from each other by an insulating paper sheet (not shown). The stator winding 22 may be wound by distributed winding or concentrated winding.

The rotator 30 is a rotator of a permanent magnet type including a rotator core 31 that allows a magnetic flux to flow therethrough, and permanent magnets 32. The rotator 30 in this embodiment is a rotator of an interior permanent magnet (IPM) type in which the permanent magnets 32 are embedded inside the rotator core 31. The permanent magnets 32 are inserted into a plurality of through holes passing through the rotator core 31 in an axial direction, respectively. The rotator 30 may be a rotator of a surface permanent magnet (SPM) type in which the permanent magnets 32 are arranged on an outer peripheral surface of the rotator core 31.

The shaft 40 passes through the rotator core 31 along a center axis of the rotator 30, and is fixed to the rotator core 31 by shrink fitting or press fitting. Torque of the rotating electric machine is transmitted to an outside via the shaft 40.

The housing 10 is formed in a cylindrical shape using metal such as iron or aluminum. A plurality of divided laminated cores 60 are fitted into the housing 10 in a state of being arranged in parallel in an annular shape. As a result, the plurality of divided laminated cores 60 are coupled to each other so that the stator core 21 having an annular shape is formed. A bracket 11 is mounted to an opening portion formed at one axial end portion of the housing 10. The shaft 40 is rotatably supported on the housing 10 through intermediation of a bearing 41, and is rotatably supported on the bracket 11 through intermediation of a bearing 42.

FIG. 2 is a perspective view for illustrating a configuration of the stator core 21 according to this embodiment. As illustrated in FIG. 2, the stator core 21 has an annular shape as a whole. The stator core 21 is formed by coupling the plurality of divided laminated cores 60 arranged in parallel in a circumferential direction to each other. The stator core 21 in this embodiment has 485 magnetic pole pieces. Each of the divided laminated cores 60 forms, for example, one magnetic pole piece of the plurality of magnetic pole pieces of the stator core 21. As described later, each of the divided laminated cores has a configuration in which a plurality of core pieces including core pieces 70A and core pieces 70B are laminated in the axial direction. That is, the stator core 21 is a laminated core having a configuration in which the plurality of core pieces are laminated. Each of the core pieces is formed using a thin plate being a magnetic steel sheet, for example, a steel sheet 130 described later. Further, as described later, each of the divided laminated cores 60 includes a back-yoke-portion laminate 61 in which back yoke portions of the plurality of core pieces are laminated, and a tooth-portion laminate 62 in which tooth portions of the plurality of core pieces are laminated.

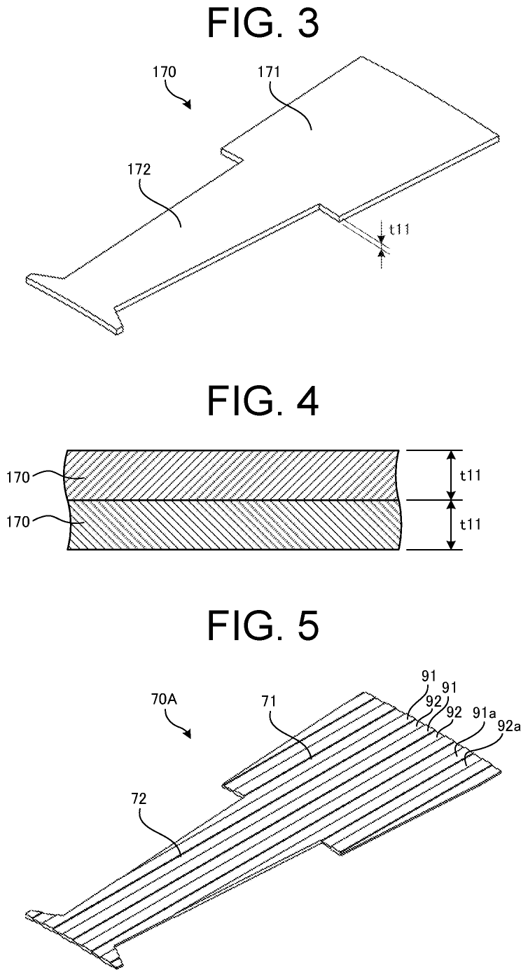

A configuration of the core piece in this embodiment is described in comparison with a configuration of a comparative example. FIG. 3 is a perspective view for illustrating a configuration of one core piece 170 in the comparative example of this embodiment. FIG. 4 is a sectional view for illustrating a configuration in which two core pieces 170 are laminated in the comparative example of this embodiment.

As illustrated in FIG. 3 and FIG. 4, the core piece 170 in the comparative example includes a back yoke portion 171 and a tooth portion 172, and is formed in a flat plate shape. One surface of the core piece 170 facing upward in FIG. 3 and FIG. 4 and the other surface of the core piece 170 facing downward in FIG. 3 and FIG. 4 are both formed flat. The core piece 170 has a plate thickness t11 substantially uniform as a whole. The plate thickness t11 is, for example, 0.35 mm. In this case, a thickness of the two laminated core pieces 170 is 0.70 mm (=0.35 mm×2). The plate thickness t11 is equal to a plate thickness of the core piece 170 at the time of purchasing or a plate thickness of the steel sheet 130 described later at the time of purchasing. In the comparative example, a plurality of core pieces 170 having the same configuration are laminated to form the divided laminated core.

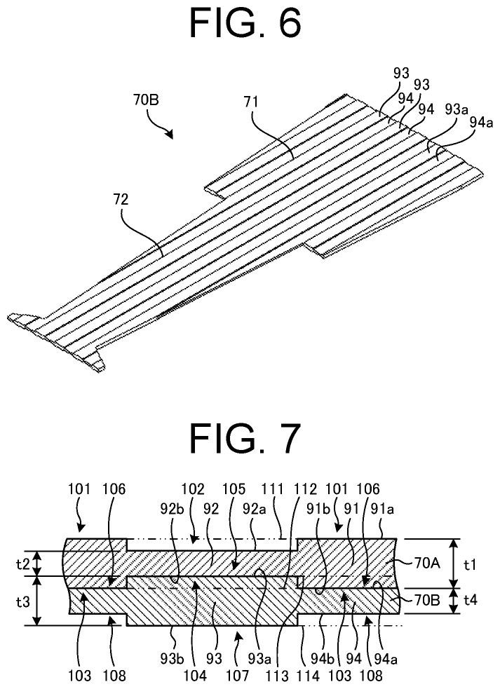

FIG. 5 is a perspective view for illustrating a configuration of the core piece 70A of the divided laminated core 60 according to this embodiment. FIG. 6 is a perspective view for illustrating a configuration of another core piece 70B of the divided laminated core 60 according to this embodiment. FIG. 7 is a sectional view for illustrating a configuration in which the core piece 70A and the core piece 70B according to this embodiment are laminated. FIG. 7 is an illustration of a cross section in which the core piece 70A and the core piece 70B are taken in a plane perpendicular to an extending direction of a first portion 91 and a second portion 92. In this embodiment, the core pieces 70A and the core pieces 70B are alternately laminated to form each of the plurality of divided laminated cores 60 illustrated in FIG. 2.

As illustrated in FIG. 5 to FIG. 7, similarly to the core piece 170 in the comparative example, each of the core piece 70A and the core piece 70B includes a back yoke portion 71 and a tooth portion 72, and is formed in a flat plate shape as a whole. The back yoke portion 71 extends along one direction perpendicular to a laminating direction of the core piece 70A and the core piece 70B. The tooth portion 72 protrudes, from a central portion of the back yoke portion 71 in an extending direction of the back yoke portion 71, in a direction perpendicular to both the laminating direction of the core piece 70A and the core piece 70B and the extending direction of the back yoke portion 71. The core piece 70A and the core piece 70B have the same flat surface shape.

In the stator core 21 illustrated in FIG. 2, the extending direction of the back yoke portion 71 corresponds to a circumferential direction of the stator core 21 or a tangential direction of the circumferential direction. In the stator core 21 illustrated in FIG. 2, a protruding direction of the tooth portion 72 corresponds to a radially inner side of the stator core 21. In the stator core 21 illustrated in FIG. 2, the laminating direction of the core piece 70A and the core piece 70B corresponds to the axial direction of the stator core 21.

The core piece 70A includes a plurality of first portions 91 each having a plate thickness t1, and a plurality of second portions 92 each having a plate thickness t2 smaller than the plate thickness t1 (t1>t2). For example, the plate thickness t1 is 0.35 mm, and the plate thickness t2 is 0.25 mm. The plate thickness t1 is equal to, for example, a plate thickness of the core piece 70A at the time of purchasing or the plate thickness of the steel sheet 130 described later at the time of purchasing. The second portion 92 is formed by crushing the steel sheet 130 described later in a plate thickness direction.

Each of the first portions 91 extends along the protruding direction of the tooth portion 72, that is, a radial direction of the stator core 21 in a band shape. The plurality of first portions 91 are arranged in parallel to each other at intervals. Each of the second portions 92 is arranged between adjacent two first portions 91. Similarly to each of the first portions 91, each of the second portions 92 extends along the protruding direction of the tooth portion 72 in a band shape. A parallel direction in which the first portions 91 and the second portions 92 are arranged in parallel is the extending direction of the back yoke portion 71, that is, the circumferential direction of the stator core 21. The plurality of first portions and the plurality of second portions 92 are alternately arranged in the extending direction of the back yoke portion 71.

In an upper surface of the core piece 70A which faces upward in FIG. 5 and FIG. 7, a surface 92a of each of the second portions 92 is formed to be recessed with respect to a plane 111 including a surface 91a of each of the first portions 91. As a result, a recessed portion 102 is formed in the second portion 92 in the upper surface of the core piece 70A. A projecting portion 101 that projects with respect to the recessed portion 102 is formed on the first portion 91 in the upper surface of the core piece 70A.

Also in a lower surface of the core piece 70A which faces downward in FIG. 5 and FIG. 7, a surface 92b of each of the second portions 92 is formed to be recessed with respect to a plane 112 including a surface 91b of each of the first portions 91. As a result, a recessed portion 104 is formed in the second portion 92 in the lower surface of the core piece 70A. A projecting portion 103 that projects with respect to the recessed portion 104 is formed on the first portion 91 in the lower surface of the core piece 70A. That is, in any of the upper surface and the lower surface of the core piece 70A, the projecting portion is formed on the first portion 91, and the recessed portion is formed in the second portion 92.

The core piece 70B includes a plurality of first portions 93 each having a plate thickness t3, and a plurality of second portions 94 each having a plate thickness t4 smaller than the plate thickness t3 (t3>t4). In this embodiment, a difference between the plate thickness t3 and the plate thickness t4 (t3−t4) is equal to a difference between the plate thickness t1 and the plate thickness t2 (t1−t2) (t3−t4=t1−t2). Further, in this embodiment, the plate thickness t3 is equal to the plate thickness t1 (t3=t1), and the plate thickness t4 is equal to the plate thickness t2 (t4=t2). The plate thickness t3 is equal to a plate thickness of the core piece 70B at the time of purchasing or the plate thickness of the steel sheet 130 described later at the time of purchasing.

Here, “equal to” herein includes not only a case of being completely equal, but also a substantially equal range which can be regarded as being substantially equal in consideration of technical knowledge.

Each of the first portions 93 extends along the protruding direction of the tooth portion 72, that is, the radial direction of the stator core 21 in a band shape. The plurality of first portions 93 are arranged in parallel to each other at intervals. Each of the second portions 94 is arranged between adjacent two first portions 93. Similarly to each of the first portions 93, each of the second portions 94 extends along the protruding direction of the tooth portion 72 in a band shape. A parallel direction in which the first portions 93 and the second portions 94 are arranged in parallel is the extending direction of the back yoke portion 71, that is, the circumferential direction of the stator core 21. The plurality of first portions and the plurality of second portions 94 are alternately arranged in the extending direction of the back yoke portion 71.

In an upper surface of the core piece 70B which faces upward in FIG. 6 and FIG. 7, a surface 94a of each of the second portions 94 is formed to be recessed with respect to a plane 113 including a surfaces 93a of each of the first portions 93. As a result, a recessed portion 106 is formed in the second portion 94 in the upper surface of the core piece 70B. A projecting portion 105 that projects with respect to the recessed portion 106 is formed on the first portion 93 in the upper surface of the core piece 70B.

Also in a lower surface of the core piece 70B which faces downward in FIG. 6 and FIG. 7, a surface 94b of each of the second portions 94 is formed to be recessed with respect to a plane 114 including a surface 93b of each of the first portions 93. As a result, a recessed portion 108 is formed in the second portion 94 in the lower surface of the core piece 70B. A projecting portion 107 that projects with respect to the recessed portion 108 is formed on the first portion 93 in the lower surface of the core piece 70B. That is, in any of the upper surface and the lower surface of the core piece 70B, the projecting portion is formed on the first portion 93, and the recessed portion is formed in the second portion 94.

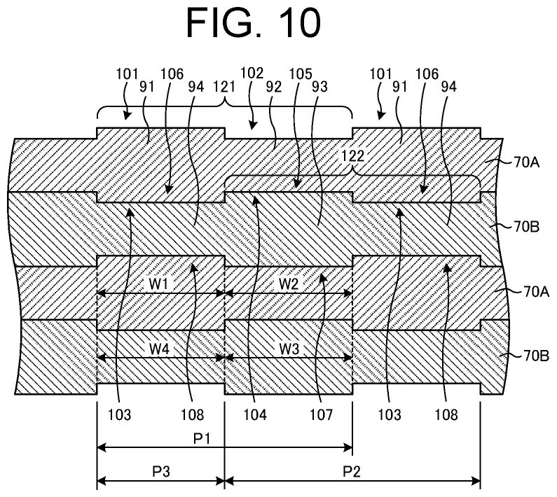

As described later with reference to FIG. 10, a width W1 of the first portion 91 of the core piece 70A is equal to a width W4 of the second portion 94 of the core piece 70B. Further, a width W2 of the second portion 92 of the core piece 70A is equal to a width W3 of the first portion 93 of the core piece 70B.

When the plurality of core pieces are to be laminated, the core piece 70A and the core piece 70B are arranged so as to be adjacent to each other in the laminating direction. When the laminated core pieces 70A and 70B are viewed along the laminating direction, the first portion 91 of the core piece 70A is arranged to be overlapped with the second portion 94 of the core piece 70B. Further, when viewed along the laminating direction, the first portion 91 of the core piece 70A is formed within a formation range of the second portion 94 of the core piece 70B. Thus, the projecting portion 103 formed on the first portion 91 of the core piece 70A is fitted to the recessed portion 106 formed in the second portion 94 of the core piece 70B.

Further, when viewed along the laminating direction, the first portion 93 of the core piece 70B is arranged to be overlapped with the second portion 92 of the core piece 70A. Further, when viewed along the laminating direction, the first portion 93 of the core piece 70B is formed within a formation range of the second portion 92 of the core piece 70A. Thus, the projecting portion 105 formed on the first portion 93 of the core piece 70B is fitted to the recessed portion 104 formed in the second portion 92 of the core piece 70A.

As a result, a thickness of the laminated core pieces 70A and 70B is t1+t4 or t2+t3. Assuming that the plate thickness t1 and the plate thickness t3 are equal to the plate thickness t11 of the core piece 170 in the comparative example, a thickness of the laminated core pieces 70A and 70B is smaller than a thickness of the two laminated core pieces 170 (2×t11) in the comparative example. For example, the thickness of the laminated core pieces 70A and 70B is 0.60 mm (=0.35 mm+0.25 mm). In this embodiment, both the plate thickness t1 and the plate thickness t3 are 0.35 mm, but the plate thickness t1 and the plate thickness t3 may be set to other dimensions such as 0.5 mm, 0.25 mm, and 0.23 mm. When each of the plate thickness t1 and the plate thickness t3 is adapted to the standards of the thin plate, a thin plate from which the core piece 70A and the core piece 70B are punched out is easily available at low cost.

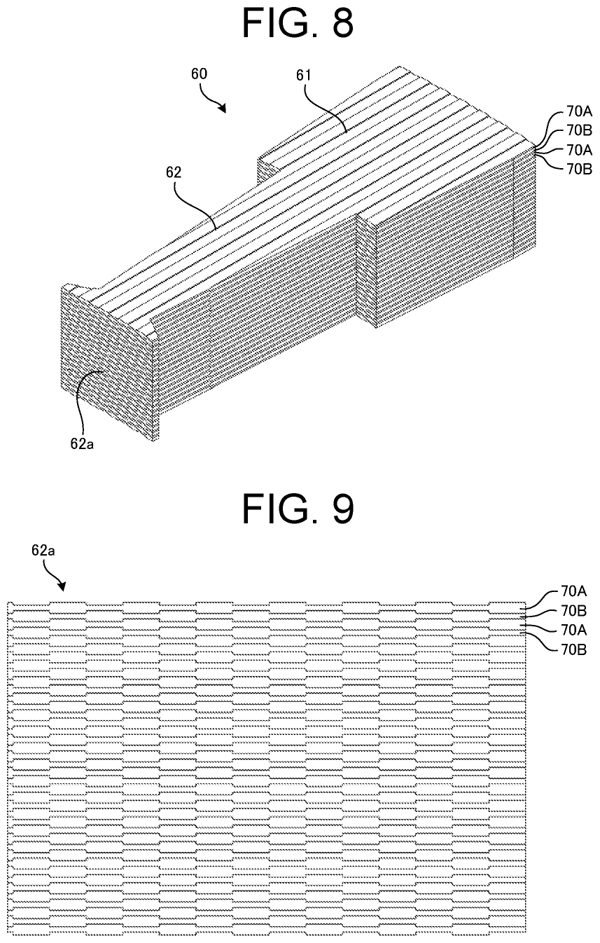

FIG. 8 is a perspective view for illustrating a configuration of the divided laminated core 60 according to this embodiment. FIG. 9 is a view for illustrating a configuration in which a distal end portion 62a of the tooth-portion laminate 62 of the divided laminated core 60 according to this embodiment is viewed along the radial direction.

As illustrated in FIG. 8 and FIG. 9, the divided laminated core 60 has a configuration in which the plurality of core pieces 70A and the plurality of core pieces 70B are alternately laminated one by one. The plurality of core pieces 70A and the plurality of core pieces 70B which are laminated may be fixed to each other by bonding, welding, or mold fixing using a resin. Alternatively, the plurality of core pieces 70A and the plurality of core pieces 70B which are laminated may be fixed to each other by caulking using a half-punched portion formed in each core piece or by fastening using a fastening member such as a rivet.

The divided laminated core 60 includes the back-yoke-portion laminate 61 and the tooth-portion laminate 62. The back-yoke-portion laminate 61 has a configuration in which the back yoke portions 71 of the plurality of core pieces 70A and the plurality of core pieces 70B are laminated. The tooth-portion laminate 62 has a configuration in which the tooth portions 72 of the plurality of core pieces 70A and the plurality of core pieces 70B are laminated. The back-yoke-portion laminate extends along the circumferential direction. The tooth-portion laminate 62 protrudes from the back-yoke-portion laminate 61 toward the radially inner side. The distal end portion 62a opposed to the outer peripheral surface of the rotator 30 is formed at an end portion of the tooth-portion laminate 62 on the radially inner side. The distal end portion 62a is formed in, for example, a flat surface shape perpendicular to the radial direction or a cylindrical surface shape along the outer peripheral surface of the rotator 30.

FIG. 10 is a sectional view for illustrating a configuration of a part of the divided laminated core 60 according to this embodiment taken along a plane perpendicular to the extending direction of the first portion 91 and the second portion 92. A right-and-left direction in FIG. 10 represents a parallel direction of the first portions 91 and the second portions 92. An up-and-down direction in FIG. 10 represents the laminating direction of the core pieces 70A and the core pieces 70B. In FIG. 10, a cross section parallel to the cross section illustrated in FIG. 7 is illustrated.

In the cross section illustrated in FIG. 10, the recessed portion 102 and the recessed portion 104 formed in the core piece 70A both have a rectangular cross-sectional shape. The projecting portion 101 and the projecting portion 103 formed on the core piece 70A both have a rectangular cross-sectional shape. Further, in the same cross section, the recessed portion 106 and the recessed portion 108 formed in the core piece 70B both have a rectangular cross-sectional shape. The projecting portion 105 and the projecting portion 107 formed on the core piece 70B both have a rectangular cross-sectional shape.

Those projecting portions and recessed portions both have a rectangular cross-sectional shape. Thus, when the core piece 70A and the core piece 70B are to be laminated, the core piece 70A and the core piece 70B can easily be positioned. Further, the core piece 70A and the core piece 70B can easily be fitted to each other, thereby being capable of temporarily fixing the core piece 70A and the core piece 70B to each other until the core piece 70A and the core piece 70B are fixed to each other by bonding, welding, or the like. Further, the core piece 70A and the core piece 70B are fitted to each other at a plurality of positions. Thus, fixing by bonding, welding, or the like may be omitted depending on the application. The width dimensions of those projecting portions and recessed portions may be set to be small to increase the number of portions at which the core piece 70A and the core piece 70B are fitted to each other.

In the cross section illustrated in FIG. 10, the width W1 of the first portion 91 of the core piece 70A, that is, the width of each of the projecting portion 101 and the projecting portion 103 is equal to the width W2 of the second portion 92 of the core piece 70A, that is, the width of each of the recessed portion 102 and the recessed portion 104. Further, in the same cross section, the width W3 of the first portion 93 of the core piece 70B, that is, the width of each of the projecting portion 105 and the projecting portion 107 is equal to the width W4 of the second portion 94 of the core piece 70B, that is, the width of each of the recessed portion 106 and the recessed portion 108. Further, the width W1, the width W2, the width W3, and the width W4 are all equal (W1=W2=W3=W4). As a result, the width W1 of the first portion 91 of the core piece 70A is equal to the width W4 of the second portion 94 of the core piece 70B, and the width W2 of the second portion 92 of the core piece 70A is equal to the width W3 of the first portion 93 of the core piece 70B. Thus, when the core piece 70A and the core piece 70B are laminated, a gap defined between the core piece 70A and the core piece 70B can be reduced. Thus, an occupancy rate of the core in the divided laminated core 60 can be increased.

In the cross section illustrated in FIG. 10, in the core piece 70A, a plurality of repeated patterns 121 each including the first portion 91 and the second portion 92 adjacent to each other are formed. The plurality of repeated patterns 121 of the core piece 70A are arranged at a pitch P1 along the parallel direction of the first portions 91 and the second portions 92. The pitch P1 is equal to the sum of the width W1 and the width W2 in the core piece 70A (P1=W1+W2).

In the same cross section, in the core piece 70B, a plurality of repeated patterns 122 each including the first portion 93 and the second portion 94 adjacent to each other are formed. The plurality of repeated patterns 122 of the core piece 70B are arranged at a pitch P2 along the parallel direction of the first portions 93 and the second portions 94. The pitch P2 is equal to the sum of the width W3 and the width W4 in the core piece 70B (P2=W3+W4), and is also equal to the pitch P1 (P2=P1).

The repeated patterns 121 of the core piece 70A and the repeated patterns 122 of the core piece 70B are arranged so as to be shifted from each other by a shift width P3. The shift width P3 corresponds to a half of each of the pitch P1 and the pitch P2, that is, a half pitch (P3=P1/2=P2/2). That is, the first portion 91 of the core piece 70A and the first portion 93 of the core piece 70B are arranged so as to be shifted from each other by the half pitch. Similarly, the second portion 92 of the core piece 70A and the second portion 94 of the core piece 70B are arranged so as to be shifted from each other by the half pitch. With this configuration, a gap can be less liable to be defined between the core piece 70A and the core piece 70B. Further, in a manufacturing process of the divided laminated core 60, which is described later, through adjustment of operation timings of a crushing machine 220 and a press machine 230, the divided laminated cores 60 can be continuously manufactured without stopping the crushing machine 220 and the press machine 230. Thus, the productivity of the divided laminated core 60 can be improved.

In general, an iron loss Wi generated in the rotating electric machine is expressed by the following expression.

Wi=Wh+We

Here, Wh is a hysteresis loss, and We is an eddy current loss.

The eddy current loss We is expressed by the following expression.

We=ke/ρ×t²×f²×B²

Here, ke is a coefficient, ρ is a resistivity of the thin plate, “t” is a plate thickness of the thin plate, “f” is a rotation speed, and B is a magnetic flux density. That is, in order to reduce the eddy current loss We, it is effective to increase the resistivity ρ, reduce the plate thickness “t”, or perform insulation treatment on a surface of the thin plate so as to cut off a path of an eddy current. For example, when the plate thickness “t” is reduced, the eddy current loss We becomes smaller in proportion to the square of the plate thickness “t”.

In this embodiment, the plate thickness t2 of at least a part of the core piece 70A and the plate thickness t4 of at least a part of the core piece 70B can be made smaller than the plate thickness t11 of the core piece 170 in the comparative example illustrated in FIG. 3 and FIG. 4. As a result, the eddy current generated in at least a part of each of the core piece 70A and the core piece 70B can be suppressed.

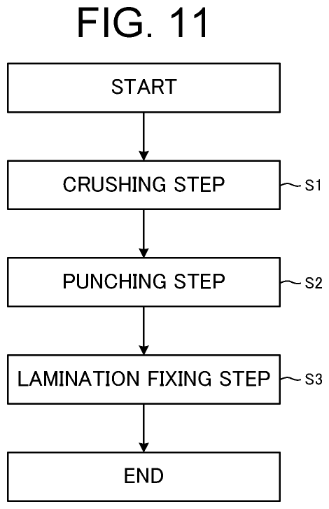

Next, the manufacturing method for a laminated core for an electric machine according to this embodiment and the manufacturing method for an electric machine are described. FIG. 11 is a flowchart for illustrating a flow of the manufacturing process of the divided laminated core 60 according to this embodiment. FIG. 12 is a conceptual diagram for illustrating a flow of the manufacturing process of the divided laminated core according to this embodiment. In FIG. 12, a schematic configuration of a manufacturing apparatus 200 configured to manufacture the divided laminated core 60 according to this embodiment is also illustrated. In the following, the flow of the manufacturing process of the divided laminated core 60 and the configuration of the manufacturing apparatus 200 are described with reference to FIG. 11 and FIG. 12.

As illustrated in FIG. 11, the manufacturing process of the divided laminated core 60 includes at least a crushing step and a punching step executed after the crushing step.

As illustrated in FIG. 12, the manufacturing apparatus 200 configured to manufacture the divided laminated core 60 includes a steel sheet supply device 210, the crushing machine 220, and the press machine 230 in the stated order in the flow of the manufacturing process. The steel sheet supply device 210, the crushing machine 220, and the press machine 230 are serially arranged in the stated order to form a serial production line. In the crushing machine 220, the crushing step is executed, and in the press machine 230, the punching step is executed. As a result, the crushing step and the punching step are executed by the serial production line.

The steel sheet supply device 210 is configured to hold the steel sheet 130 wound in a hoop shape. The steel sheet 130 is formed using a thin plate being a non-oriented magnetic steel sheet. Further, the steel sheet supply device 210 includes a feeding device configured to feed the steel sheet 130 in a band shape in a right direction in FIG. 12. As a result, the steel sheet 130 in a band shape is supplied from the steel sheet supply device 210 to the crushing machine 220. The plate thickness of the steel sheet 130 supplied to the crushing machine 220 is equal to the plate thickness of the steel sheet 130 given in an initial state, which is wound in a hoop shape.

In the crushing machine 220, the crushing step of Step S1 in FIG. 11 is executed. The crushing step is a step of crushing a part of the steel sheet 130. The crushing machine 220 is configured to press and crush a part of the steel sheet 130, which is supplied from the steel sheet supply device 210, in the plate thickness direction. The crushing machine 220 includes a lower table 221 arranged below the steel sheet 130, an upper table 222 arranged above the steel sheet 130, and a drive mechanism (not shown) configured to drive the upper table 222 in the up-and-down direction with respect to the lower table 221. A tool portion 223 is provided to the lower table 221. A tool portion 224 is provided to the upper table 222. The tool portion 223 and the tool portion 224 are opposed to each other across the steel sheet 130.

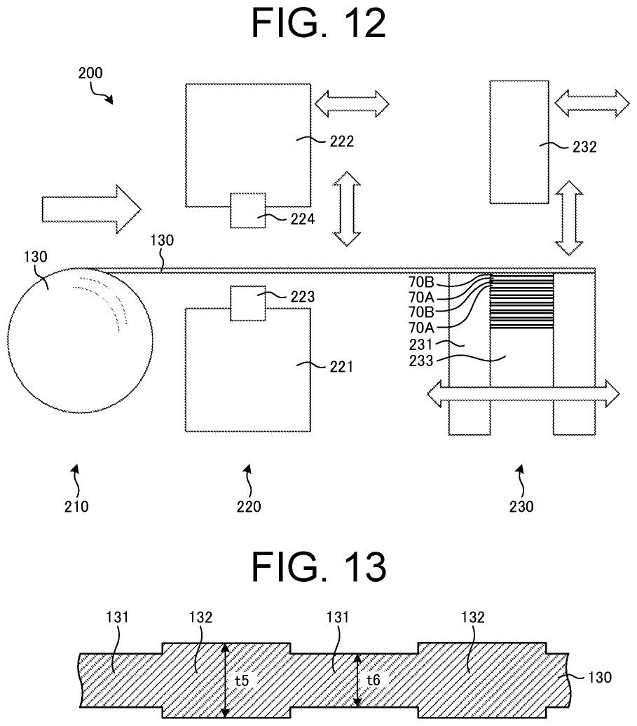

FIG. 13 is a sectional view for illustrating a configuration of the steel sheet 130 after the crushing step in the manufacturing process of the divided laminated core according to this embodiment. As illustrated in FIG. 13, when a part of the steel sheet 130 is crushed by the crushing machine 220, a thin portion 131 having a plate thickness t6 smaller than the plate thickness t5 of the steel sheet 130 given in an initial state is formed at that part (t5>t6). The thin portion 131 serves as the second portion 92 of the core piece 70A or the second portion 94 of the core piece 70B.

Meanwhile, a portion other than the thin portion 131 in the steel sheet 130 is maintained to have the plate thickness t5 given in an initial state. This portion serves as a thick portion 132 having the plate thickness t5 larger than the plate thickness t6 of the thin portion 131. The thick portion 132 serves as the first portion 91 of the core piece 70A or the first portion 93 of the core piece 70B.

Although illustration is omitted, the tool portion 223 has a protruding portion that protrudes in a direction toward a lower surface of the steel sheet 130. Similarly, the tool portion 224 has a protruding portion that protrudes in a direction toward an upper surface of the steel sheet 130. Those protruding portions have flat surface shapes symmetrical across the steel sheet 130. The thin portion 131 is formed by crushing a part of the steel sheet 130 from both the upper side and the lower side by the protruding portion of the tool portion 223 and the protruding portion of the tool portion 224. As a result, the recessed portion is formed in the thin portion 131 in each of the upper surface and the lower surface of the steel sheet 130. Each of the tool portion 223 and the tool portion 224 is only required to have the protruding portion that protrudes in one direction, and hence can have a simpler structure than that of a general die.

When a plurality of thin portions 131 are to be formed in the steel sheet 130, a plurality of protruding portions may be formed on each of the tool portion 223 and the tool portion 224. As a result, the plurality of thin portions 131 can be formed in the steel sheet 130 by one application of pressure by the crushing machine 220. Thus, even when the plurality of thin portions 131 are to be formed in the steel sheet 130, takt time of the crushing step can be prevented from becoming longer.

When the plurality of thin portions 131 are to be formed in the steel sheet 130, the thin portions 131 can be formed one by one. In this case, regardless of the number of the thin portions 131 to be formed in the steel sheet 130, it is only required that only one protruding portion is formed on each of the tool portion 223 and the tool portion 224.

For example, when the plurality of thin portions 131 are to be formed in the steel sheet 130 at a constant pitch, first, the thin portion 131 at a first portion is formed, and next, the steel sheet 130 is fed by one pitch to form the thin portion 131 at a second portion. After that, feeding of the steel sheet 130 and formation of the thin portion 131 are repeated to form a required number of the thin portions 131 in the steel sheet 130. In this case, the number of the protruding portions in each of the tool portion 223 and the tool portion 224 can be reduced so that each of the tool portion 223 and the tool portion 224 can be further simplified in structure, thereby being capable of suppressing the equipment investment for the crushing machine 220. As a result, manufacturing cost of the divided laminated core 60 can be reduced.

In the crushing step, the steel sheet 130 is not cut. Thus, the steel sheet 130 having the thin portion 131 formed therein is fed from the crushing machine 220 to the press machine 230 in a next step using the above-mentioned feeding device.

In the press machine 230, the punching step of Step S2 in FIG. 11 is executed. The punching step is a step of punching out each of the core piece 70A and the core piece 70B from the steel sheet 130. As illustrated in FIG. 12, the press machine 230 includes a die 231 arranged below the steel sheet 130, a punch 232 arranged above the steel sheet 130, and a drive mechanism (not shown) configured to drive the punch 232 in the up-and-down direction with respect to the die 231. The punch 232 has the same flat surface shape as that of each of the core piece 70A and the core piece 70B. The punch 232 is driven so as to be fitted into the die 231 by the drive mechanism. As a result, the press machine 230 can punch out the core piece 70A or the core piece 70B one by one from the steel sheet 130. The core piece 70A or the core piece 70B having been punched out is removed and dropped into an internal space 233 of the die 231.

The plurality of core pieces 70A and the plurality of core pieces 70B are alternately punched out one by one from the steel sheet 130. That is, in the press machine 230, a step of punching out one core piece 70A from the steel sheet 130 and a step of punching out one core piece 70B from the steel sheet 130 are alternately repeated. As a result, in the internal space 233 of the die 231, the plurality of core pieces 70A and the plurality of core pieces 70B are alternately stacked one by one. In the manufacturing process illustrated in FIG. 12, the steel sheet 130 is continuously fed to the press machine 230. Thus, in the internal space 233, the plurality of core pieces 70A and the plurality of core pieces 70B are stacked one after another. As a result, the productivity of the core piece 70A, the core piece 70B, and the divided laminated core 60 obtained by laminating the core pieces can be improved.

Further, in the punching step, a feeding pitch of the steel sheet 130 at the time of punching out the core piece 70A and a feeding pitch of the steel sheet 130 at the time of punching out the core piece 70B may be made different by, for example, the shift width P3 illustrated in FIG. 10. As a result, each of the core piece 70A and the core piece 70B can be punched out easily from the steel sheet 130, thereby being capable of improving the productivity of the core piece 70A and the core piece 70B.

Further, each of the crushing machine 220 and the press machine 230 may be configured so as to be movable along a feeding direction of the steel sheet 130. Continuous processing of the core piece 70A and the core piece 70B can easily be performed by adjusting the feeding pitch of the steel sheet 130 while adjusting the position of each of the crushing machine 220 and the press machine 230.

Although illustration is omitted in FIG. 12, after the punching step, a lamination fixing step of Step S3 of fixing the plurality of core pieces 70A and the plurality of core pieces 70B, which are alternately stacked, to each other is executed. In the lamination fixing step, for example, the plurality of core pieces 70A and the plurality of core pieces 70B which are alternately stacked are bonded to each other via an adhesive. In this case, an adhesive layer is formed between the core piece 70A and the core piece 70B adjacent to each other. As a result, the core piece 70A and the core piece 70B adjacent to each other are fixed to each other through intermediation of the adhesive layer, thereby manufacturing the divided laminated core 60. As a method of applying an adhesive, there is given a method of immersing the plurality of core pieces 70A and the plurality of core pieces 70B which are alternately stacked in a thermosetting adhesive put in a bath, and then, heating the plurality of core pieces 70A and the plurality of core pieces 70B in a heating furnace. As a result, the adhesive is cured, and the plurality of core pieces 70A and the plurality of core pieces 70B are fixed to each other. Further, as a method other than the bonding, there is given a method of putting the plurality of core pieces 70A and the plurality of core pieces 70B which are alternately stacked in a die for resin molding, and pouring a resin into the die. As a result, the plurality of core pieces 70A and the plurality of core pieces 70B are integrated together with the resin.

A required number of, for example, forty-eight divided laminated cores 60 manufactured in this manner are prepared. Those divided laminated cores 60 are arranged in parallel in an annular shape and coupled to each other, thereby manufacturing the stator core 21 of the rotating electric machine. When the plurality of divided laminated cores 60 are to be coupled to each other, welding or bonding may be used, or fixing by resin molding may be used. The stator winding 22 is mounted to the stator core 21, thereby manufacturing the stator 20. The stator winding 22 may be mounted to each of the plurality of divided laminated cores 60, and then, those divided laminated cores 60 may be arranged in parallel in an annular shape and coupled to each other.

Further, through a step of inserting the rotator 30 and the shaft 40 into the inner peripheral side of the stator 20, the rotating electric machine illustrated in FIG. 1 is obtained.

In this embodiment, the punching step is executed after the crushing step. As a result, even when the steel sheet 130 is deformed or changed in dimension in the crushing step, in the punching step, the core piece 70A and the core piece 70B can be punched out with accuracy corresponding to the processing accuracy of the press machine 230. Thus, the core piece 70A and the core piece 70B with high dimensional accuracy and high geometric accuracy can easily be obtained. As a result, the dimensional accuracy and the geometric accuracy of the divided laminated core 60 manufactured using the core pieces 70A and the core pieces 70B can be improved.

Assuming that the punching step is executed before the crushing step, even when the dimensional accuracy and the geometric accuracy of each of the core piece 70A and the core piece 70B are ensured in the punching step, the dimensional accuracy and the geometric accuracy are deteriorated in the subsequent crushing step. Thus, after the crushing step, a step for improving the dimensional accuracy and the geometric accuracy of each of the core piece 70A and the core piece 70B may be further required. Further, the core piece 70A and the core piece 70B punched out in the punching step are required to be fed one by one to the crushing step, with the result that it takes time to convey the core piece 70A and the core piece 70B from the punching step to the crushing step.

Each of the core piece 70A and the core piece 70B in this embodiment includes the first portion and the second portion as two portions having the plate thicknesses different from each other. However, each of the core piece 70A and the core piece 70B may include three or more portions having plate thicknesses different from each other. That is, each of the core piece 70A and the core piece 70B may include the first portion, the second portion having the plate thickness smaller than the plate thickness of the first portion, and a third portion having a plate thickness smaller than the plate thickness of the second portion.

As described above, the divided laminated core 60 according to this embodiment includes the core pieces 70A and the core pieces 70B as the plurality of laminated core pieces. The core piece 70A includes the first portions 91, and the second portions 92 each having the plate thickness t2 smaller than the plate thickness t1 of the first portion 91. The core piece 70B includes the first portions 93, and the second portions 94 each having the plate thickness t4 smaller than the plate thickness t3 of the first portion 93. Here, the divided laminated core 60 is an example of a laminated core for an electric machine.

According to the above-mentioned configuration, the plate thickness t2 of the second portion 92 can be made smaller than the plate thickness t1 of the first portion 91. The eddy current loss is proportional to the square of the plate thickness of the core piece. Thus, according to the above-mentioned configuration, the eddy current loss in the second portion 92 of the core piece 70A can be reduced. Similarly, according to the above-mentioned configuration, the eddy current loss in the second portion 94 of the core piece 70B can be reduced. Thus, according to the above-mentioned configuration, the eddy current loss in the divided laminated core 60 can be reduced. As a result, the iron loss generated in the rotating electric machine can be reduced, thereby being capable of improving the efficiency of the rotating electric machine.

In this embodiment, the plate thickness t1 of the first portion 91 is equal to the plate thickness of the steel sheet 130 at the time of purchasing. Further, the second portion 92 having the plate thickness t2 smaller than the plate thickness t1 is formed by crushing the steel sheet 130. Thus, the core piece 70A can be manufactured using the steel sheet 130 which is easily available at low cost. Similarly, the core piece 70B can be manufactured using the steel sheet 130 which is easily available at low cost. Thus, according to this embodiment, the eddy current loss in the divided laminated core 60 can be reduced while the material cost is suppressed.

In the divided laminated core 60 according to this embodiment, the plurality of core pieces include the core pieces 70A, and the core pieces 70B each adjacent to the core piece 70A in the laminating direction of the plurality of core pieces. The first portion 91 of the core piece 70A overlaps with the second portion 94 of the core piece 70B when viewed along the laminating direction. The second portion 92 of the core piece 70A overlaps with the first portion 93 of the core piece 70B when viewed along the laminating direction. Here, the core piece 70A is an example of a first core piece. The core piece 70B is an example of a second core piece.

According to this configuration, a gap defined between the core piece 70A and the core piece 70B can be made smaller. Thus, the occupancy rate of the core in the divided laminated core 60 can be improved. Further, the core piece 70A and the core piece 70B can be manufactured using the same manufacturing apparatus 200. Thus, the manufacturing cost of the divided laminated core 60 can be reduced, thereby being capable of achieving the electric machine which is more inexpensive.

In the divided laminated core 60 according to this embodiment, in the core piece 70A, the first portions 91 and the second portions 92 are arranged in parallel to each other in one direction. In the core piece 70B, the first portions 93 and the second portions 94 are arranged in parallel to each other in one direction. The width W2 of the second portion 92 of the core piece 70A in the parallel direction of the first portions and the second portions is equal to the width W4 of the second portion 94 of the core piece 70B in the parallel direction.

In the divided laminated core 60 according to this embodiment, in the core piece 70A, the plurality of repeated patterns 121 each including the first portion 91 and the second portion 92 adjacent to each other are formed. In the core piece 70B, the plurality of repeated patterns 122 each including the first portion 93 and the second portion 94 adjacent to each other are formed. The plurality of repeated patterns 121 of the core piece 70A and the plurality of repeated patterns 122 of the core piece 70B are arranged at the same pitch P1 or P2 along the parallel direction, and are shifted from each other by the half pitch.

According to this configuration, a gap is less liable to be defined between the core piece 70A and the core piece 70B. Further, in the manufacturing process of the divided laminated core 60, through adjustment of the operation timings of the crushing machine 220 and the press machine 230, the divided laminated cores 60 can continuously be manufactured without stopping the crushing machine 220 and the press machine 230.

In the divided laminated core 60 according to this embodiment, in one surface of the core piece 70A, the recessed portions 102 each having a rectangular cross section in which the surface 92a of the second portion 92 is recessed with respect to the plane 111 including the surfaces 91a of the first portions 91 are formed. In the other surface of the core piece 70A, the recessed portions 104 each having a rectangular cross section in which the surface 92b of the second portion 92 is recessed with respect to the plane 112 including the surfaces 91b of the first portions 91 are formed. Similarly, in one surface of the core piece 70B, the recessed portions 106 each having a rectangular cross section in which the surface 94a of the second portion 94 is recessed with respect to the plane 113 including the surfaces 93a of the first portions 93 are formed. In the other surface of the core piece 70B, the recessed portions 108 each having a rectangular cross section in which the surface 94b of the second portion 94 is recessed with respect to the plane 114 including the surfaces 93b of the first portions 93 are formed.

According to this configuration, the core piece 70A and the core piece 70B can easily be positioned. Further, according to this configuration, the projecting portions formed on one of the core piece 70A or the core piece 70B and the recessed portions formed in the other one of the core piece 70A or the core piece 70B are fitted to each other so that fixing of the core piece 70A and the core piece 70B via bonding, welding, and the like may become unnecessary.

In the divided laminated core 60 according to this embodiment, each of the core piece 70A and the core piece 70B includes the back yoke portion 71, and the tooth portion 72 protruding from the back yoke portion 71. The second portions 92 and the second portions 94 in the tooth portions 72 extend along the protruding direction of the tooth portion 72.

In the rotating electric machine, a magnetic flux that enters the stator core 21 from the rotator 30 flows in the radial direction in the tooth portion 72, that is, the protruding direction of the tooth portion 72. Thus, according to the above-mentioned configuration, the second portions 92 and the second portions 94 in the tooth portions 72 can be formed longer along the direction in which the magnetic flux flows. Thus, the eddy current in the tooth portion 72 can effectively be suppressed, thereby being capable of reducing the eddy current loss in the tooth portion 72. This embodiment can obtain a higher effect when being applied to such a rotating electric machine that the magnetic flux density of the tooth portion 72 is larger than the magnetic flux density of the back yoke portion 71.

In the divided laminated core 60 according to this embodiment, the second portions 92 and the second portions 94 in the back yoke portions 71 and the second portions 92 and the second portions 94 in the tooth portions 72 extend in the same direction. According to this configuration, the second portions 92 and the second portions 94 can easily be formed.

In the divided laminated core 60 according to this embodiment, all the second portions 92 in the core piece 70A extend in the same direction, and all the second portions 94 in the core piece 70B extend in the same direction. According to this configuration, the second portions 92 and the second portions 94 can easily be formed.

In the divided laminated core 60 according to this embodiment, the plate thickness t1 of the first portion 91 and the plate thickness t3 of the first portion 93 are 0.35 mm or 0.5 mm. In general, a thin plate having a plate thickness of 0.35 mm and a thin plate having a plate thickness of 0.5 mm are easily available. Thus, according to the above-mentioned configuration, the material of the core piece 70A and the core piece 70B can easily be obtained at low cost. The plate thickness t2 of the second portion 92 and the plate thickness t4 of the second portion 94 may be 0.25 mm or less.

In the divided laminated core 60 according to this embodiment, in one surface of the core piece 70A, the recessed portions 102 in which the one surface 92a of the second portion 92 is recessed with respect to the plane 111 including the one surfaces 91a of the first portions 91 are formed. In the other surface of the core piece 70A, the recessed portions 104 in which the other surface 92b of the second portion 92 is recessed with respect to the plane 112 including the other surfaces 91b of the first portions 91 are formed. Similarly, in one surface of the core piece 70B, the recessed portions 106 in which the one surface 94a of the second portion 94 is recessed with respect to the plane 113 including the one surfaces 93a of the first portions 93 are formed. In the other surface of the core piece 70B, the recessed portions 108 in which the other surface 94b of the second portion 94 is recessed with respect to the plane 114 including the other surfaces 93b of the first portions 93 are formed. Here, the recessed portion 102 and the recessed portion 106 are examples of a first recessed portion. The recessed portion 104 and the recessed portion 108 are examples of a second recessed portion. According to this configuration, the recessed portions can be formed in both surfaces of each core piece. Those recessed portions are formed by pressing a thin plate from both surfaces by the protruding portions of the tool portion 223 and the tool portion 224 in the crushing machine 220 used in the crushing step. Each of the tool portion 223 and the tool portion 224 is only required to include the protruding portion that protrudes in one direction. Thus, the tool portion 223 and the tool portion 224 of the crushing machine 220 can be simplified in structure.

The rotating electric machine according to this embodiment includes the stator 20 including the divided laminated cores 60, and the rotator 30 arranged so as to be opposed to the stator 20 via the air gap 50. Here, the rotating electric machine is an example of an electric machine. The stator 20 is an example of an armature. The rotator 30 is an example of a field system. According to this configuration, the effects described above can be obtained in the rotating electric machine.

The manufacturing method for the divided laminated core 60 according to this embodiment includes the crushing step, and the punching step executed after the crushing step. The crushing step is a step of crushing a part of the steel sheet 130 to form the thin portion 131 that serves as the second portion 92 or the second portion 94. The punching step is a step of punching out each of the core piece 70A and the core piece 70B from the steel sheet 130. Here, the manufacturing method for the divided laminated core 60 is an example of a manufacturing method for a laminated core for an electric machine.

According to this manufacturing method, even when the steel sheet 130 is deformed or changed in dimension in the crushing step, in the punching step, each of the core piece 70A and the core piece 70B can be punched out with accuracy corresponding to the processing accuracy of the press machine 230. Thus, the core piece 70A and the core piece 70B with high dimensional accuracy and high geometric accuracy can easily be obtained.

In the manufacturing method for the divided laminated core 60 according to this embodiment, in the crushing step, the thin portions 131 at a plurality of positions may be formed one by one. According to this manufacturing method, a pressure load required in the crushing step is reduced, thereby being capable of suppressing the equipment investment for the crushing machine 220. Further, when the thin portions 131 at a plurality of positions are to be formed at one time, it is difficult to provide a relief that allows elongation of the steel sheet 130 in the crushing step so that the thin portion 131 may not be able to be formed. In contrast, according to the above-mentioned manufacturing method, it becomes easier to provide a relief that allows elongation of the steel sheet 130.

In the manufacturing method for the divided laminated core 60 according to this embodiment, in the crushing step, the thin portions 131 at a plurality of positions may be formed at one time. In the crushing step, all the thin portions 131, for example, all the thin portions 131 included in one core piece may be formed at one time. According to the manufacturing method, even when the plurality of thin portions 131 are to be formed, the takt time of the crushing step can be prevented from becoming longer. Thus, deterioration in the productivity of the divided laminated core 60 can be suppressed, thereby being capable of obtaining the divided laminated core 60 and the stator core 21 which are inexpensive.

The manufacturing method for the electric machine according to this embodiment includes the manufacturing method for the divided laminated core 60 according to this embodiment. According to this configuration, in the manufacturing method for the electric machine, the same effects as those described above can be obtained.

### Second Embodiment

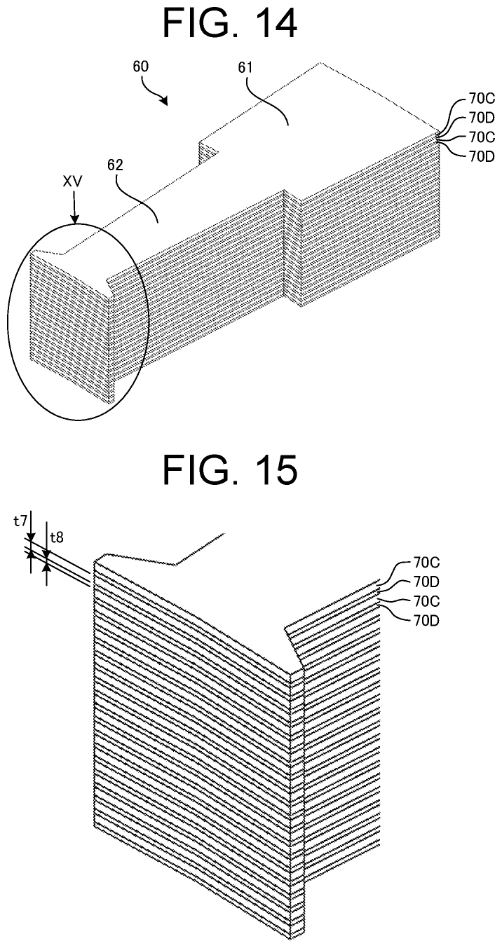

A laminated core for an electric machine according to a second embodiment is described. FIG. 14 is a perspective view for illustrating a configuration of a divided laminated core 60 according to this embodiment. FIG. 15 is a view for illustrating the XV portion of FIG. 14 in an enlarged manner. Description of configurations similar to those of the first embodiment is omitted.

As illustrated in FIG. 14 and FIG. 15, the divided laminated core 60 according to this embodiment has a configuration in which a plurality of core pieces 70C each having a plate thickness t7 and a plurality of core pieces 70D each having a plate thickness t8 smaller than the plate thickness t7 are alternately laminated one by one (t7>t8). That is, the divided laminated core 60 has a configuration in which first core piece groups each including one core piece 70C and second core piece groups each including one core piece 70D are alternately arranged in the laminating direction. Each of the core piece 70C and the core piece 70D has a flat plate shape in which no protrusion and recess is formed on a surface. That is, each of the core piece 70C and the core piece 70D has a plate thickness substantially uniform as a whole.

The plate thickness t7 of the core piece 70C is equal to the plate thickness of the steel sheet 130 at the time of purchasing. The core piece 70D having the plate thickness t8 is formed by crushing the steel sheet 130 in the plate thickness direction. That is, the divided laminated core 60 according to this embodiment can be manufactured by the same manufacturing process as that of the first embodiment using the steel sheet 130 having the plate thickness t7. In the crushing step, in the steel sheet 130, at least an entire area of a portion that serves as the core piece 70D is crushed. Meanwhile, in the steel sheet 130, at least an entire area of a portion that serves as the core piece 70C is not crushed in the crushing step.

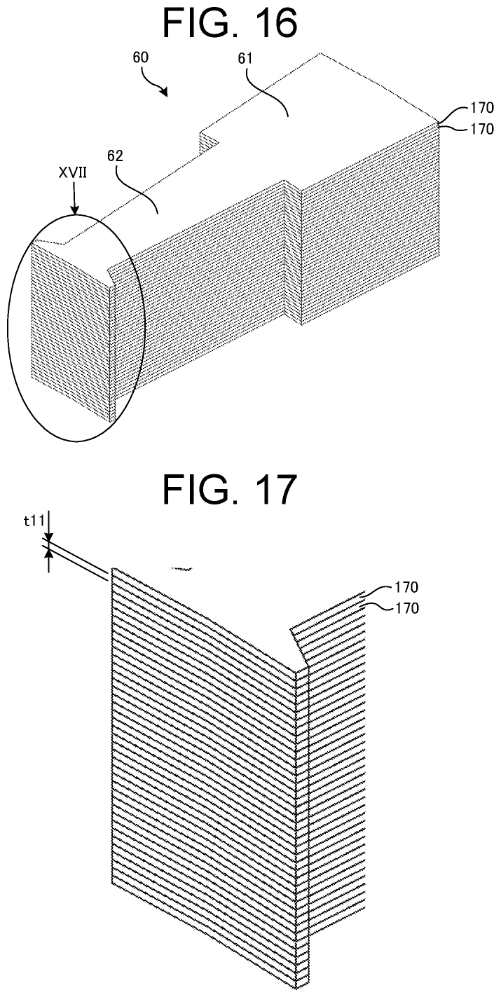

FIG. 16 is a perspective view for illustrating a configuration of a divided laminated core 60 according to a comparative example of this embodiment. FIG. 17 is a view for illustrating the XVII portion of FIG. 16 in an enlarged manner. As illustrated in FIG. 16 and FIG. 17, the divided laminated core 60 according to the comparative example has a configuration in which the plurality of core pieces 170 having the same plate thickness t11 are laminated. The plate thickness t11 of the core piece 170 is equal to the plate thickness of the steel sheet 130 at the time of purchasing.

Assuming that the plate thickness t7 of the core piece 70C is equal to the plate thickness t11 of the core piece 170, the plate thickness t8 of the core piece 70D is smaller than the plate thickness t11. Thus, according to this embodiment, the eddy current can be suppressed, and the eddy current loss can be reduced. That is, according to this embodiment, the eddy current loss can be reduced more than that in the configuration in which the plurality of core pieces 170 having the same plate thickness t11 are laminated.

Further, the core piece 70D in this embodiment is formed by crushing the steel sheet 130 which is easily available in the plate thickness direction. Thus, according to this embodiment, the purchase cost of the core piece 70D can be suppressed, thereby being capable of reducing the manufacturing cost of the divided laminated core 60.

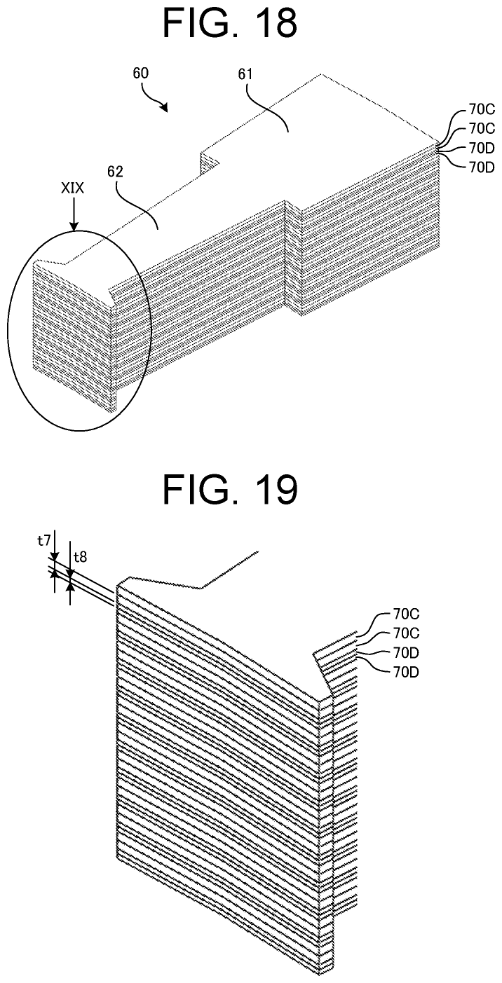

FIG. 18 is a perspective view for illustrating a first modification example of the configuration of the divided laminated core 60 according to this embodiment. FIG. 19 is a view for illustrating the XIX portion of FIG. 18 in an enlarged manner. As illustrated in FIG. 18 and FIG. 19, the divided laminated core 60 in this modification example has a configuration in which the plurality of core pieces 70C each having the plate thickness t7 and the plurality of core pieces 70D each having the plate thickness t8 smaller than the plate thickness t7 are alternately laminated for a plurality of sheets. That is, the divided laminated core 60 has a configuration in which the first core piece groups each including the plurality of core pieces 70C and the second core piece groups each including the plurality of core pieces 70D are alternately arranged in the laminating direction. The first core piece group or the second core piece group may be formed of one core piece. When the plurality of first core piece groups are provided, the number of the core pieces 70C forming each first core piece group may vary Further, when the plurality of second core piece groups are provided, the number of the core pieces 70D forming each second core piece group may vary. Also according to the divided laminated core 60 in this modification example, the same effects as those of the divided laminated core 60 illustrated in FIG. 14 and FIG. 15 can be obtained. Further, the divided laminated core 60 in this modification example can also be manufactured by the same manufacturing process as that in the first embodiment.

In general, it is known that a unit price of a material having the plate thickness t8 which is relatively small is higher than a unit price of a material having the plate thickness t7 which is relatively large. In this modification example, the core pieces 70C each having the plate thickness t7 and the core pieces 70D each having the plate thickness t8 are alternately laminated for a plurality of sheets. As a result, as compared to a configuration in which one or a plurality of the core pieces 70C are arranged at each end in the laminating direction, and the plurality of core pieces 70D are laminated therebetween, in this modification example, the number of the core pieces 70D each having the plate thickness t8 which is relatively small can be reduced. Thus, according to this modification example, both when a material having the plate thickness t8 is purchased and when a part or an entirety of the material having the plate thickness t7 is crushed to form the material having the plate thickness t8, the divided laminated core 60 which is inexpensive can be obtained.

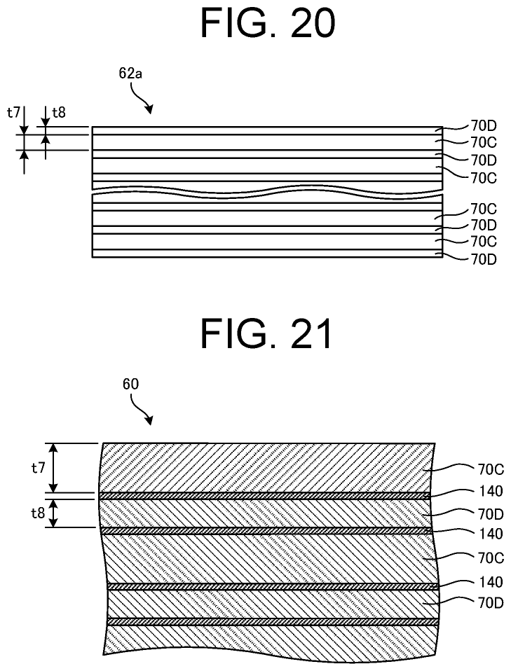

FIG. 20 is a view for illustrating a second modification example of the configuration of the divided laminated core 60 according to this embodiment. FIG. 20 is an illustration of a configuration in which the distal end portion 62a of the tooth-portion laminate 62 of the divided laminated core 60 is viewed along the radial direction. As illustrated in FIG. 20, in this modification example, unlike the configurations illustrated in FIG. 14, FIG. 15, FIG. 18, and FIG. 19, the core pieces 70D each having the plate thickness t8 which is relatively small are arranged at both ends of the plurality of core pieces in the laminating direction. That is, the second core piece groups each including one or more core pieces 70D are arranged at both ends of the plurality of core pieces in the laminating direction. As a result, the eddy current loss caused by the magnetic flux flowing from the end portions in the laminating direction can be reduced.

FIG. 21 is a partial sectional view for illustrating a third modification example of the configuration of the divided laminated core 60 according to this embodiment. In general, the core pieces forming the laminated core of the rotating electric machine are each formed using a non-oriented magnetic steel sheet in order to reduce a magnetic loss. Also in this modification example, each of the core piece 70C and the core piece 70D is formed using a non-oriented magnetic steel sheet. However, insulation coating is not applied to the surface of the non-oriented magnetic steel sheet used in this modification example. That is, insulation coating is absent on the surface of each of the core piece 70C and the core piece 70D.

As illustrated in FIG. 21, two core pieces adjacent to each other in the laminating direction, for example, the core piece 70C and the core piece 70D are fixed to each other via an adhesive layer 140 having an insulation property. The adhesive layer 140 is formed using an adhesive having an insulation property. As the adhesive having an insulation property, an anaerobic adhesive, a thermosetting adhesive, an instant adhesive, or the like is used.

A manufacturing method for the divided laminated core 60 in this modification example is described with reference to FIG. 11 and FIG. 12. As the material of the plurality of core pieces of the divided laminated core 60, the steel sheet 130 without insulation coating applied thereto is purchased. The plate thickness of the steel sheet 130 is equal to the plate thickness t7 of the core piece 70C punched out from the steel sheet 130 in a subsequent step.

In the crushing step, in the steel sheet 130, at least the entire area of a portion that serves as the core piece 70D is crushed. As a result, the plate thickness of the portion that serves as the core piece 70D is smaller than the plate thickness t7, and is, for example, equal to the plate thickness t8 of the core piece 70D punched out from the steel sheet 130 in a subsequent step. Meanwhile, in the steel sheet 130, at least the entire area of a portion that serves as the core piece 70C is not crushed in the crushing step. As a result, the portion that serves as the core piece 70C is, for example, maintained to have the plate thickness of the steel sheet 130 at the time of purchasing.

Next, in the punching step, each of the core piece 70C and the core piece 70D is punched out from the steel sheet 130 using the press machine 230 and the like. The core piece 70C is punched out from a portion of the steel sheet 130 which is not crushed in the crushing step, and the core piece 70D is punched out from a portion of the steel sheet 130 which is crushed in the crushing step. As a result, the plurality of core pieces 70C and the plurality of core pieces 70D are formed. Insulation coating is not applied to each of the plurality of core pieces 70C and the plurality of core pieces 70D. The core piece 70D may be punched out from the steel sheet 130 entirely crushed in the crushing step, and the core piece 70C may be punched out from another steel sheet 130 which is not crushed.

Next, in the lamination fixing step, the first core piece groups each including one or more core pieces 70C and the second core piece groups each including one or more core pieces 70D are alternately laminated. Two core pieces adjacent to each other in the laminating direction are fixed to each other via the adhesive layer 140 having an insulation property.

In this modification example, the steel sheet 130 without insulation coating applied thereto is used as the material of the core piece, thereby being capable of reducing the material cost and the processing cost. In general, a sheet material having insulation coating applied thereto is limited to a magnetic steel sheet. In contrast, in this modification example, the steel sheet 130 without insulation coating applied thereto is used, thereby being capable of forming the core piece using various sheet materials other than the magnetic steel sheet. As a result, the range of selection of the material is increased so that the core piece can be obtained in a more inexpensive manner depending on the selected material. Further, even when the magnetic steel sheet is used as the material of the core piece, the magnetic steel sheet without insulation coating applied thereto can be used, thereby being capable of obtaining the core piece in a more inexpensive manner. Thus, according to this modification example, the material cost of the divided laminated core 60 can be reduced.

Further, in this modification example, two core pieces adjacent to each other in the laminating direction are fixed to each other using an adhesive having an insulation property. Thus, as compared to a configuration in which the core pieces adjacent to each other are not insulated from each other or a configuration in which the core pieces adjacent to each other are fixed to each other by caulking or the like, the eddy current loss can be reduced while the core pieces are firmly fixed to each other.

Assuming that insulation coating is applied to the steel sheet, when the steel sheet is to be crushed in the crushing step, an insulating coating film formed on the surface of the steel sheet may be removed. When the removed insulating coating film enters the portion between the core pieces at the time of laminating the plurality of core pieces, an occupancy rate of the core in the divided laminated core 60 is reduced. In contrast, in this modification example, the insulating coating film is not formed on the steel sheet 130, thereby being capable of preventing the reduction of the occupancy rate of the core as described above.

As described above, the divided laminated core 60 according to this embodiment includes the plurality of laminated core pieces. The plurality of core pieces include the core pieces 70C, and the core pieces 70D each having the plate thickness t8 smaller than the plate thickness t7 of the core piece 70C. The first core piece groups each including one or more core pieces 70C and the second core piece groups each including one or more core pieces 70D are alternately arranged in the laminating direction of the plurality of core pieces. Here, the divided laminated core 60 is an example of a laminated core for an electric machine. The core piece 70C is an example of a third core piece. The core piece 70D is an example of a fourth core piece.

According to this configuration, the divided laminated core 60 can be formed using the core pieces 70D each having a smaller plate thickness, thereby being capable of reducing the eddy current loss in the divided laminated core 60. As a result, the iron loss generated in the rotating electric machine can be reduced, thereby being capable of improving the efficiency of the rotating electric machine.

In the divided laminated core 60 according to this embodiment, the above-mentioned second core piece groups are arranged at both ends of the plurality of core pieces in the laminating direction. According to this configuration, the eddy current loss caused by the magnetic flux flowing from the end portions in the laminating direction can be reduced.

In the divided laminated core 60 according to this embodiment, insulation coating is not applied to each of the plurality of core pieces. Two core pieces adjacent to each other in the laminating direction among the plurality of core pieces are fixed to each other via the adhesive layer 140 having an insulation property. According to this configuration, the material cost of the divided laminated core 60 can be reduced.

The manufacturing method for the divided laminated core 60 according to this embodiment includes the crushing step, and the punching step executed after the crushing step. The crushing step is a step of crushing a part or an entirety of the steel sheet 130 to form the thin portion 131 that serves as the core piece 70D. The punching step is a step of punching out each of the core piece 70C and the core piece 70D from the steel sheet 130. The core piece 70D is punched out from the thin portion 131 of the steel sheet 130. The core piece 70C is punched out form, for example, the thick portion 132 of the steel sheet 130 which is a portion other than the thin portion 131. The core piece 70C may be punched out from another steel sheet 130 which is not crushed.

According to this manufacturing method, even when the steel sheet 130 is deformed or changed in dimension in the crushing step, in the punching step, each of the core piece 70C and the core piece 70D can be punched out with accuracy corresponding to the processing accuracy of the press machine 230. Thus, the core piece 70C and the core piece 70D with high dimensional accuracy and high geometric accuracy can easily be obtained.

The manufacturing method for the divided laminated core 60 according to this embodiment further includes the lamination fixing step. The lamination fixing step is a step of laminating and fixing the plurality of core pieces punched out in the punching step. Insulation coating is not applied to each of the plurality of core pieces. In the lamination fixing step, two core pieces adjacent to each other in the laminating direction among the plurality of core pieces are fixed to each other via the adhesive layer 140 having an insulation property. According to this manufacturing method, the material cost of the divided laminated core 60 can be reduced.

### Third Embodiment

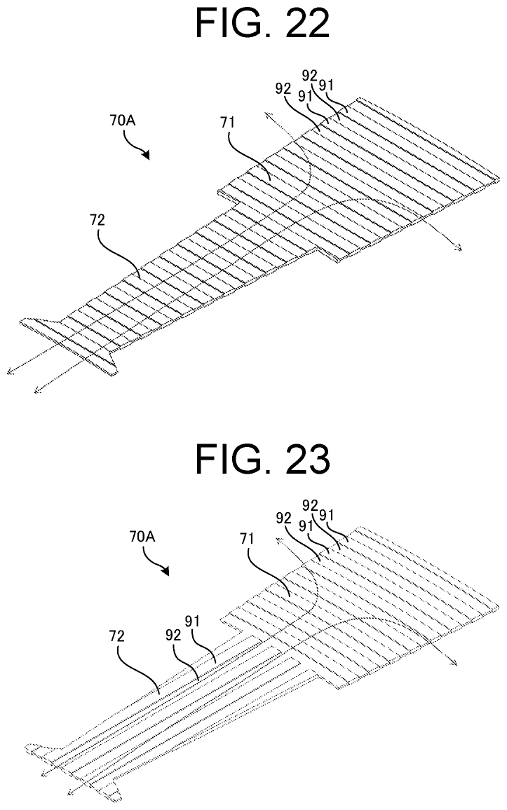

A laminated core for an electric machine according to a third embodiment is described. FIG. 22 is a perspective view for illustrating a configuration of a core piece 70A of a divided laminated core 60 according to this embodiment. The core piece 70A in this embodiment is different from the core piece 70A in the first embodiment in the extending direction of each of the plurality of second portions 92. Description of configurations similar to those of the first or second embodiment is omitted.

As illustrated in FIG. 22, in both the back yoke portion 71 and the tooth portion 72, each of the plurality of second portions 92 in the core piece 70A extends in a band shape along the extending direction of the back yoke portion 71, that is, the circumferential direction of the stator core 21. Similarly, in both the back yoke portion 71 and the tooth portion 72, each of the plurality of first portions 91 in the core piece 70A extends in a band shape along the extending direction of the back yoke portion 71. The parallel direction in which the first portions 91 and the second portions 92 are arranged in parallel is the protruding direction of the tooth portion 72, that is, the radial direction of the stator core 21.

Although illustration is omitted, the core piece 70B to be laminated together with the core piece 70A includes the first portions 93 formed at positions corresponding to the second portions 92 of the core piece 70A, and the second portions 94 formed at positions corresponding to the first portions 91 of the core piece 70A. Also in the core piece 70B, each of the plurality of second portions 94 and each of the plurality of first portions 93 extend in a band shape along the extending direction of the back yoke portion 71, that is, the circumferential direction of the stator core 21.

As described above, in the divided laminated core 60 according to this embodiment, each of the core piece 70A and the core piece 70B includes the back yoke portion 71, and the tooth portion 72 protruding from the back yoke portion 71. The second portions 92 and the second portions 94 in the back yoke portion 71 extend along the extending direction of the back yoke portion 71.

In the rotating electric machine, as indicated by the arrows in FIG. 22, the magnetic flux that enters the stator core 21 from the rotator 30 flows in the radial direction in the tooth portion 72, and flows in the circumferential direction in the back yoke portion 71. That is, in this embodiment, the second portions 92 and the second portions 94 in the back yoke portions 71 can be formed longer along the direction in which the magnetic flux flows. Thus, the eddy current in the back yoke portion 71 can effectively be suppressed, thereby being capable of reducing the eddy current loss in the back yoke portion 71. This embodiment can obtain a higher effect when being applied to such a rotating electric machine that the magnetic flux density of the back yoke portion 71 is larger than the magnetic flux density of the tooth portion 72.

### Fourth Embodiment

A laminated core for an electric machine according to a fourth embodiment is described. FIG. 23 is a perspective view for illustrating a configuration of a core piece 70A of a divided laminated core 60 according to this embodiment. The core piece 70A in this embodiment is different from the core piece 70A in the first embodiment in the extending direction of each of the plurality of second portions 92. Description of configurations similar to those of any of the first to third embodiments is omitted.

As illustrated in FIG. 23, each of the plurality of second portions 92 in the back yoke portion 71 of the core piece 70A extends in a band shape along the extending direction of the back yoke portion 71, that is, the circumferential direction of the stator core 21. Similarly, each of the plurality of first portions 91 in the back yoke portion 71 of the core piece 70A extends in a band shape along the extending direction of the back yoke portion 71.

Meanwhile, each of the plurality of second portions 92 in the tooth portion 72 of the core piece 70A extends in a band shape along the extending direction of the tooth portion 72, that is, the radial direction of the stator core 21. Similarly, each of the plurality of first portions 91 in the tooth portion 72 of the core piece 70A extends in a band shape along the extending direction of the tooth portion 72.

Although illustration is omitted, the core piece 70B to be laminated together with the core piece 70A includes the first portions 93 formed at positions corresponding to the second portions 92 of the core piece 70A, and the second portions 94 formed at positions corresponding to the first portions 91 of the core piece 70A. In the back yoke portion 71 of the core piece 70B, each of the plurality of second portions 94 and each of the plurality of first portions 93 extend along the extending direction of the back yoke portion 71. In the tooth portion 72 of the core piece 70B, each of the plurality of second portions 94 and each of the plurality of first portions 93 extend along the extending direction of the tooth portion 72.

As described above, in the divided laminated core 60 according to this embodiment, each of the core piece 70A and the core piece 70B includes the back yoke portion 71, and the tooth portion 72 protruding from the back yoke portion 71. The second portions 92 and the second portions 94 in the back yoke portion 71 extend along the extending direction of the back yoke portion 71. The second portions 92 and the second portions 94 in the tooth portions 72 extend along the protruding direction of the tooth portion 72.

In the rotating electric machine, as indicated by the arrows in FIG. 23, the magnetic flux that enters the stator core 21 from the rotator 30 flows in the radial direction in the tooth portion 72, and flows in the circumferential direction in the back yoke portion 71. That is, in this embodiment, the second portions 92 and the second portions 94 in the back yoke portions 71 can be formed longer along the direction in which the magnetic flux flows. Further, in this embodiment, also the second portions 92 and the second portions 94 in the tooth portions 72 can be formed longer along the direction in which the magnetic flux flows. Thus, as compared to the first and third embodiments, the eddy current can more effectively be suppressed. Thus, the eddy current loss in the stator core 21 can be reduced, thereby being capable of increasing the efficiency of the rotating electric machine.

### Fifth Embodiment

A laminated core for an electric machine according to a fifth embodiment is described. FIG. 24 is a perspective view for illustrating a configuration of a core piece 70A of a divided laminated core 60 according to this embodiment. The core piece 70A in this embodiment is different from the core piece 70A in the first embodiment in the extending direction of each of the plurality of second portions 92 and the extending direction of each of the plurality of first portions 91. Description of configurations similar to those of any of the first to fourth embodiments is omitted.

As illustrated in FIG. 24, in both the back yoke portion 71 and the tooth portion 72, each of the plurality of second portions 92 in the core piece 70A extends in one direction inclined with respect to both the extending direction of the back yoke portion 71 and the protruding direction of the tooth portion 72. The extending direction of each of the plurality of second portions 92 is inclined at, for example, 45° with respect to both the extending direction of the back yoke portion 71 and the protruding direction of the tooth portion 72.

Similarly, in both the back yoke portion 71 and the tooth portion 72, each of the plurality of first portions 91 in the core piece 70A extends in one direction inclined with respect to both the extending direction of the back yoke portion 71 and the protruding direction of the tooth portion 72. The extending direction of each of the first portions 91 is parallel to the extending direction of each of the second portions 92.

Although illustration is omitted, the core piece 70B to be laminated together with the core piece 70A includes the first portions 93 formed at positions corresponding to the second portions 92 of the core piece 70A, and the second portions 94 formed at positions corresponding to the first portions 91 of the core piece 70A. Each of the plurality of second portions 94 and each of the plurality of first portions 93 in the core piece 70B extend in the direction inclined with respect to both the extending direction of the back yoke portion 71 and the protruding direction of the tooth portion 72.

In the rotating electric machine, the magnetic flux that enters the stator core 21 from the rotator 30 flows in the radial direction in the tooth portion 72 and flows in the circumferential direction in the back yoke portion 71. In the configuration of the fourth embodiment illustrated in FIG. 23, the second portions 92 of the tooth portion 72 extend along the radial direction, and the second portions 92 of the back yoke portion 71 extend along the circumferential direction, thereby being capable of effectively suppressing the eddy current. However, in the configuration of the fourth embodiment, a step of forming the second portion 92 of the tooth portion 72 and a step of forming the second portion 92 of the back yoke portion 71 may be separately required.

In contrast, the second portions 92 in this embodiment extend in one direction in both the back yoke portion 71 and the tooth portion 72. As a result, the entire second portion 92 of the core piece 70A can be formed by one step, thereby being capable of improving the productivity of the divided laminated core 60. Further, separate tool portions are not required to be used when the second portion 92 of the tooth portion 72 is to be formed and when the second portion 92 of the back yoke portion 71 is to be formed, thereby being capable of suppressing the manufacturing cost of the tool portions in the crushing machine 220.

The second portions 92 in this embodiment extend in one direction inclined with respect to both the extending direction of the back yoke portion 71 and the protruding direction of the tooth portion 72. As a result, at least some of the second portions 92 are formed long along the direction in which the magnetic flux flows, thereby being capable of suppressing the eddy current. According to this embodiment, particularly when the magnetic flux density of the back yoke portion 71 and the magnetic flux density of the tooth portion 72 are substantially equal to each other, the eddy current can be suppressed while the productivity of the divided laminated core 60 is improved.

As described above, in the divided laminated core 60 according to this embodiment, each of the core piece 70A and the core piece 70B includes the back yoke portion 71, and the tooth portion 72 protruding from the back yoke portion 71. The second portions 92 and the second portions 94 extend in the direction inclined with respect to both the extending direction of the back yoke portion 71 and the protruding direction of the tooth portion 72. According to this configuration, the eddy current can be suppressed while the productivity of the divided laminated core 60 is improved.

### Sixth Embodiment

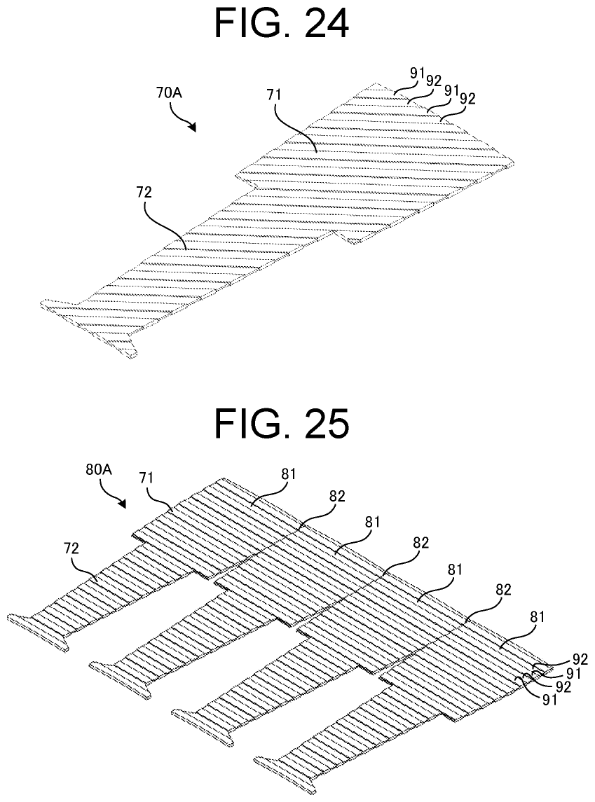

A laminated core for an electric machine according to a sixth embodiment is described. FIG. 25 is a perspective view for illustrating a configuration of a core piece 80A of the stator core 21 according to this embodiment. Description of configurations similar to those of any of the first to fifth embodiments is omitted.

As illustrated in FIG. 25, the core piece 80A in this embodiment is a unit core including a plurality of sub-core pieces 81. The core piece 80A includes the plurality of sub-core pieces 81 arranged in parallel to each other, and coupling portions 82 each coupling two sub-core pieces 81 adjacent to each other. The core piece 80A illustrated in FIG. 25 includes four sub-core pieces 81 and three coupling portions 82. The number of sub-core pieces 81 included in one core piece 80A may be two, three, or five or more.

Each of the sub-core pieces 81 includes the back yoke portion 71 and the tooth portion 72. The coupling portion 82 couples end portions of the back yoke portions 71 in the extending direction of the two sub-core pieces 81 adjacent to each other. The back yoke portions 71 of the plurality of sub-core pieces 81 are linearly arranged in parallel via the coupling portions 82. The coupling portion 82 has a configuration capable of being bent in a plane parallel to the core piece 80A. For example, similarly to the second portion 92, the coupling portion 82 has a plate thickness smaller than the plate thickness of the first portion 91.

Each of the plurality of second portions 92 in the core piece 80A extends in a band shape along the extending direction of the back yoke portion 71. Similarly, each of the plurality of first portions 91 in the core piece 80A extends in a band shape along the extending direction of the back yoke portion 71.

Although illustration is omitted, another core piece to be laminated together with the core piece 80A includes first portions formed at positions corresponding to the second portions 92 of the core piece 80A, and second portions formed at positions corresponding to the first portions 91 of the core piece 80A. Also in the above-mentioned another core piece, each of the plurality of second portions and each of the plurality of first portions extend in a band shape along the extending direction of the back yoke portion 71.

The core pieces 80A and the above-mentioned another core pieces are alternately laminated to form a laminated unit core. The coupling portions 82 are bent in the plane parallel to the core piece 80A such that the protruding direction of each of the tooth portions 72 faces a center of an annular ring. As a result, the extending direction of each of the second portions 92 matches the circumferential direction of the stator core 21. The coupling portions 82 may be bent before the plurality of core pieces are laminated or after the plurality of core pieces are laminated. A plurality of laminated unit cores are coupled to each other in an annular shape, thereby forming the stator core 21 being the laminated core.

In this embodiment, the plurality of sub-core pieces 81 are coupled to each other, thereby being capable of reducing the time and effort required at the time of conveyance between steps. Further, the plurality of sub-core pieces 81 are coupled to each other. Thus, continuous winding can easily be achieved, and connection processing time can be shortened.

The plurality of core pieces which are laminated may be fixed to each other by bonding, welding, or mold fixing using a resin. Alternatively, the plurality of core pieces which are laminated may be fixed to each other by caulking using a half-punched portion formed in each core piece or by fastening using a fastening member such as a rivet.

In the core piece 80A in this embodiment, the second portions 92 extend along the extending direction of the back yoke portion 71, but are not limited thereto. For example, as illustrated in FIG. 5, the second portions 92 may extend along the protruding direction of the tooth portion 72. Further, as illustrated in FIG. 23, the second portions 92 in the back yoke portion 71 may extend along the extending direction of the back yoke portion 71, and the second portions 92 in the tooth portion 72 may extend along the protruding direction of the tooth portion 72. Further, as illustrated in FIG. 24, the second portions 92 may extend in the direction inclined with respect to both the extending direction of the back yoke portion 71 and the protruding direction of the tooth portion 72.

As described above, in the stator core 21 according to this embodiment, each of the plurality of core pieces includes the plurality of sub-core pieces 81 arranged in parallel, and the coupling portions 82 each coupling two sub-core pieces 81 adjacent to each other. The coupling portions 82 are bent in a plane parallel to each of the plurality of core pieces. According to this configuration, the time and effort required at the time of conveyance between steps can be reduced, and the connection processing time can be shortened, thereby being capable of reducing the manufacturing cost of the stator core 21.

### Seventh Embodiment

A laminated core for an electric machine according to a seventh embodiment is described. FIG. 26 is a plan view for illustrating a configuration of a core piece 83A of the stator core 21 according to this embodiment. The stator core 21 according to this embodiment is different from the stator core 21 in the first embodiment in that the stator core 21 is not divided into the plurality of divided laminated cores 60. That is, the stator core 21 according to this embodiment has a configuration in which a plurality of core pieces 83A each having an annular shape are laminated. Description of configurations similar to those of any of the first to sixth embodiments is omitted.

As illustrated in FIG. 26, the core piece 83A in this embodiment has an annular shape. The core piece 83A is formed by being integrally punched out from one steel sheet 130. The core piece 83A includes the back yoke portion 71 having an annular shape and extending in the circumferential direction, and a plurality of tooth portions 72 protruding from the back yoke portion 71 to the radially inner side.

The core piece 83A includes the plurality of first portions 91, and the plurality of second portions 92 each having a plate thickness smaller than the plate thickness of the first portion 91. In the entire core piece 83A, the plurality of second portions 92 extend in a band shape in parallel to each other. Similarly, in the entire core piece 83A, the plurality of first portions 91 extend in a band shape in parallel to each other. The second portions 92 extend in parallel to each other in the entire core piece 83A. Thus, in the crushing step, the steel sheet 130 is only required to be crushed along one direction. As a result, it is not required to rotate the steel sheet 130 or rotate the tool portion 223 and the tool portion 224 of the crushing machine 220, thereby being capable of improving the productivity of the stator core 21.

Although illustration is omitted, another core piece to be laminated together with the core piece 83A includes first portions formed at positions corresponding to the second portions 92 of the core piece 83A, and second portions formed at positions corresponding to the first portions 91 of the core piece 83A. Also in the above-mentioned another core piece, each of the plurality of second portions and each of the plurality of first portions extend in a band shape along the extending direction of the back yoke portion 71.

The core pieces 83A and the above-mentioned another core pieces are alternately laminated to form the stator core 21 being the laminated core. In this embodiment, a step of coupling the plurality of divided laminated cores 60 to each other in an annular shape is not required, thereby being capable of improving the productivity of the stator core 21 more than that in the first embodiment.

### Eighth Embodiment

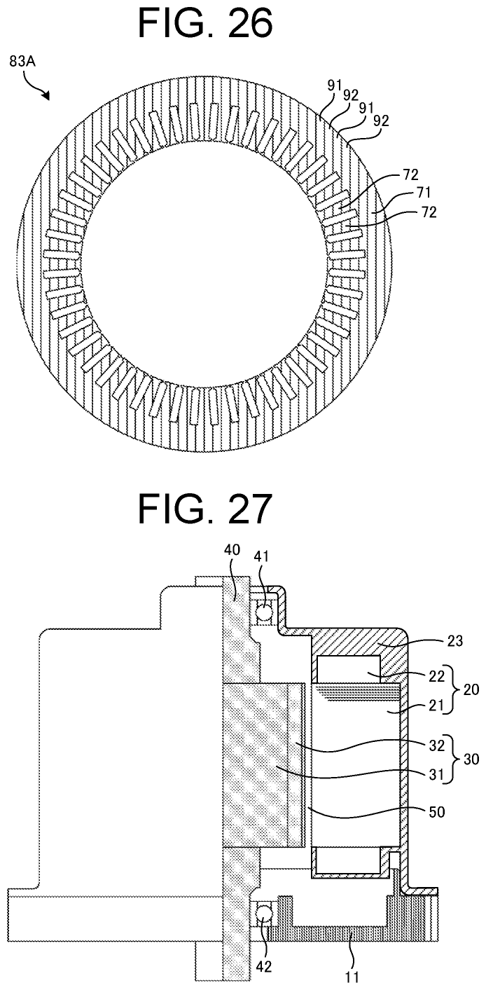

An electric machine according to an eighth embodiment is described. In this embodiment, a rotating electric machine is described as an example of the electric machine. FIG. 27 is a sectional view for illustrating a schematic configuration of the rotating electric machine according to this embodiment. As illustrated in FIG. 27, the rotating electric machine according to this embodiment is different from the rotating electric machine according to the first embodiment in including a mold member 23 made of a resin that covers the stator core 21. In the first embodiment, the housing 10 is provided on an outer peripheral side of the stator 20. In contrast, in this embodiment, the housing 10 is omitted, and the housing 10 is substituted by the mold member 23. The mold member 23 forms an outer shell of the rotating electric machine together with the bracket 11. The mold member 23 is molded so as to cover not only the stator core 21 but also the entire stator 20 including the stator core 21 and the stator winding 22. The mold member 23 is in close contact with both the stator core 21 and the stator winding 22.

One axial end portion of the mold member 23 is formed such that the bearing 41 is fitted therein. As a result, the stator core 21 and the bearing 41 are coaxially arranged more reliably. The stator core 21 includes the plurality of divided laminated cores 60 arranged in parallel in an annular shape. The mold member 23 is formed so as to cover the plurality of divided laminated cores 60 and fix the plurality of divided laminated cores 60 to each other.

The mold member 23 is provided, thereby being capable of omitting assembly work for bonding or welding the divided laminated cores 60 to each other. Further, a portion in which the bearing 41 is fitted can be formed simultaneously when the mold member 23 is to be molded. That is, in this embodiment, in the manufacturing process of the rotating electric machine in the first embodiment, a step of manufacturing the housing 10 and a step of coupling the plurality of divided laminated cores 60 to each other can be aggregated into one step. As a result, in this embodiment, the rotating electric machine which is still more inexpensive can be achieved, and a production facility of the rotating electric machine can be reduced in size.

Next, a manufacturing method for the mold member 23 is described. First, the plurality of divided laminated cores 60 arranged in parallel in an annular shape are installed inside a resin molding die. Next, a resin is injected into the resin molding die and cured to form the mold member 23. As a result, the plurality of divided laminated cores 60 are molded and fixed by the mold member 23 obtained by curing the resin. As the resin, a polyphenylenesulfide resin, a polyacetal resin, an epoxy resin, or the like is used.

In general, when the heat radiation property of the stator is low in the rotating electric machine, it is required to increase the heat radiation property of the stator by increasing an outer diameter of the stator to increase the heat radiation area or separately providing a cooling fan. As a result, the rotating electric machine may be increased in size or cost. In contrast, in this embodiment, the stator winding 22 is covered by the mold member 23 in a close contact manner, and hence heat generated in the stator winding 22 is efficiently transmitted to the mold member 23. The heat transmitted to the mold member 23 is released to the outside from the mold member 23. As a result, the heat radiation property of the stator 20 can be improved while the increase in size and cost of the rotating electric machine is suppressed.

Further, the mold member 23 that covers the stator winding 22 has a function of holding a state after the stator winding 22 is wound. As a result, the position of the stator winding 22 can be prevented from being shifted due to vibration during operation of the rotating electric machine or vibration during transportation of the rotating electric machine. Thus, the stator winding 22 can be prevented from coming into contact with the stator core 21.

When connecting wires (not shown) for connecting the stator windings 22 wound around the plurality of divided laminated cores 60 to each other are provided, the mold member 23 is formed so as to also cover the connecting wires. As a result, the positions of the connecting wires are fixed, thereby being capable of preventing the positions of the connecting wires from being shifted due to vibration during operation of the rotating electric machine or vibration during transportation of the rotating electric machine. Thus, the connecting wires can be prevented from coming into contact with the stator core 21.

The stator windings 22 and the connecting wires are protected by the mold member 23. Thus, even when the rotating electric machine is used in an environment in which refrigerant, fuel, oil, or the like may adhere, adhesion of refrigerant, fuel, oil, or the like to the stator windings 22 and the connecting wires can be prevented. As a result, deterioration of the stator windings 22 and the connecting wires can be suppressed.

As described above, in the rotating electric machine according to this embodiment, the stator 20 includes the plurality of divided laminated cores 60 arranged in parallel in an annular shape. The rotating electric machine further includes the mold member 23 made of a resin. The mold member 23 is formed so as to cover the plurality of divided laminated cores 60 and is configured to fix the plurality of divided laminated cores 60. Here, the rotating electric machine is an example of an electric machine. The stator 20 is an example of an armature. The divided laminated core 60 is an example of a laminated core.

According to this configuration, heat generated in the stator winding 22 is efficiently transmitted to the mold member 23 and is released to the outside from the mold member 23. Thus, the heat radiation property of the stator 20 can be improved while the increase in size and cost of the rotating electric machine is suppressed. Further, according to this configuration, the plurality of divided laminated cores 60 can be fixed by the mold member 23, thereby being capable of obtaining the stator 20 having high rigidity in an inexpensive manner.

When the mold member 23 is formed so as to cover the stator windings 22, positional shift and deterioration of the stator windings 22 can be prevented by the mold member 23, thereby being capable of obtaining a highly reliable rotating electric machine. Further, when the mold member 23 is formed so as to cover the connecting wires, positional shift and deterioration of the connecting wires can be prevented by the mold member 23, thereby being capable of obtaining a highly reliable rotating electric machine.

The steel sheet 130 and each core piece in the above-mentioned first to eighth embodiments are formed using a non-oriented magnetic steel sheet, but may be formed using an oriented magnetic steel sheet or an iron-based magnetic material such as SPCC or SS400.

Further, in the above-mentioned first to eighth embodiments, the rotating electric machine is described as an example of the electric machine, but the present invention is not limited thereto. The above-mentioned first to eighth embodiments may be applied to various electric machines in which a laminated core is used, such as a linear motor and a transformer.

The above-mentioned embodiments and modification examples may be carried out in combination with each other.

### REFERENCE SIGNS LIST

10 housing, 11 bracket, 20 stator, 21 stator core, 22 stator winding, 23 mold member, 30 rotator, 31 rotator core, 32 permanent magnet, 40 shaft, 41, 42 bearing, 50 air gap, 60 divided laminated core, 61 back-yoke-portion laminate, 62 tooth-portion laminate, 62a distal end portion, 70A, 70B, 70C, 70D core piece, 71 back yoke portion, 72 tooth portion, 80A core piece, 81 sub-core piece, 82 coupling portion, 83A core piece, 91 first portion, 91a, 91b surface, 92 second portion, 92a, 92b surface, 93 first portion, 93a, 93b surface, 94 second portion, 94a, 94b surface, 101 projecting portion, 102 recessed portion, 103 projecting portion, 104 recessed portion, 105 projecting portion, 106 recessed portion, 107 projecting portion, 108 recessed portion, 111, 112, 113, 114 plane, 121, 122 repeated pattern, 130 steel sheet, 131 thin portion, 132 thick portion, 140 adhesive layer, 170 core piece, 171 back yoke portion, 172 tooth portion, 200 manufacturing apparatus, 210 steel sheet supply device, 220 crushing machine, 221 lower table, 222 upper table, 223, 224 tool portion, 230 press machine, 231 die, 232 punch, 233 internal space, P1, P2 pitch, P3 shift width, W1, W2, W3, W4 width, t1, t2, t3, t4, t5, t6, t7, t8, t11 plate thickness

1.-26. (canceled)

27. A laminated core for an electric machine, comprising a plurality of laminated core pieces,
wherein each of the plurality of core pieces includes:
a first portion; and
a second portion having a plate thickness smaller than a plate thickness of the first portion,
wherein each of the plurality of core pieces includes a back yoke portion, and a tooth portion protruding from the back yoke portion, and
wherein the second portion in the back yoke portion and the second portion in the tooth portion extend along the same direction.

28. The laminated core for an electric machine according to claim 27, wherein the second portion extends in a direction inclined with respect to both an extending direction of the back yoke portion and a protruding direction of the tooth portion.

29. The laminated core for an electric machine according to claim 27,
wherein the plurality of core pieces include a first core piece, and a second core piece adjacent to the first core piece in a laminating direction of the plurality of core pieces,
wherein, in one surface of the first core piece, a first recessed portion in which one surface of the second portion is recessed with respect to a plane including one surface of the first portion is formed,
wherein, in one surface of the first portion, a first projecting portion that projects with respect to the first recessed portion is formed,
wherein, in the other surface of the second core piece, a second recessed portion in which the other surface of the second portion is recessed with respect to a plane including the other surface of the first portion is formed,
wherein, in the other surface of the first portion, a second projecting portion that projects with respect to the second recessed portion is formed,
wherein the first projecting portion is fitted to the second recessed portion, and
wherein the second projecting portion is fitted to the first recessed portion.

30. The laminated core for an electric machine according to claim 27,
wherein the plurality of core pieces include a first core piece, and a second core piece adjacent to the first core piece in a laminating direction of the plurality of core pieces,
wherein the first portion of the first core piece overlaps with the second portion of the second core piece when viewed along the laminating direction, and
wherein the second portion of the first core piece overlaps with the first portion of the second core piece when viewed along the laminating direction.

31. The laminated core for an electric machine according to claim 29,
wherein, in each of the first core piece and the second core piece, the first portion and the second portion are arranged in parallel to each other in one direction, and
wherein, in a parallel direction of the first portion and the second portion, a width of the second portion of the first core piece is equal to a width of the second portion of the second core piece in the parallel direction.

32. The laminated core for an electric machine according to claim 29,
wherein, in each of the first core piece and the second core piece, a plurality of repeated patterns each including the first portion and the second portion adjacent to each other are formed, and
wherein the plurality of repeated patterns of the first core piece and the plurality of repeated patterns of the second core piece are arranged at the same pitch along a parallel direction of the first portion and the second portion, and are shifted from each other by a half pitch.

33. The laminated core for an electric machine according to claim 27, wherein each of the plurality of core pieces includes a plurality of sub-core pieces arranged in parallel, and a coupling portion coupling two sub-core pieces adjacent to each other.

34. The laminated core for an electric machine according to claim 27, the plate thickness of the first portion is 0.35 mm or 0.5 mm.

35. An electric machine, comprising:
an armature including the laminated core for an electric machine of claim 27; and
a field system arranged so as to be opposed to the armature via an air gap.

36. The electric machine according to claim 35,
wherein the armature includes a plurality of laminated cores arranged in parallel in an annular shape, and
wherein the electric machine further comprises a mold member made of a resin which is formed so as to cover the plurality of laminated cores and is configured to fix the plurality of laminated cores.

37. A manufacturing method for a laminated core for an electric machine,
the laminated core including a plurality of laminated core pieces,
each of the plurality of core pieces including:
a first portion; and
a second portion having a plate thickness smaller than a plate thickness of the first portion,
the manufacturing method comprising:
a crushing step of crushing at least a part of a steel sheet to form thin portions at a plurality of positions which each serve as the second portion; and
a punching step of punching out each of the plurality of core pieces from the steel sheet after the crushing step,
wherein, in the crushing step, after a first thin portion among the thin portions at the plurality of positions is formed, the steel sheet is fed in a predetermined direction by a predetermined pitch to form a second thin portion among the thin portions at the plurality of positions at a position apart from the first thin portion in the predetermined direction by the predetermined pitch.

38. The manufacturing method for a laminated core for an electric machine according to claim 37, wherein, in the crushing step, the thin portions at a plurality of positions are formed one by one.

39. The manufacturing method for a laminated core for an electric machine according to claim 37, in the crushing step, the thin portions at a plurality of positions are formed at one time.

40. A manufacturing method for an electric machine, comprising the manufacturing method for a laminated core for an electric machine of claim 37.
